(19) United States
(12) Patent Application Publication
(10) Pub. No.: US 2013/0275330 A1
(43) Pub. Date: Oct. 17, 2013

(54) Assigning a Risk Profile to a Guarantee Product and Payment of Associated Fees

(71) Applicants: Tim Bennett, Marion, IA (US); Darin Smith, Marion, IA (US); Kevin Roper, Cedar Rapids, IA (US); Larry Lickteig, Hiawatha, IA (US); Josh Pinnick, Cox's Creek, KY (US); Matthew Krigbaum, Marion, IA (US)

(72) Inventors: Tim Bennett, Marion, IA (US); Darin Smith, Marion, IA (US); Kevin Roper, Cedar Rapids, IA (US); Larry Lickteig, Hiawatha, IA (US); Josh Pinnick, Cox's Creek, KY (US); Matthew Krigbaum, Marion, IA (US)

(73) Assignee: TRANSAMERICA CORPORATION, San Francisco, CA (US)

(21) Appl. No.: 13/447,206

(22) Filed: Apr. 14, 2012

(51) Int. Cl. G06Q 40/06

(52) U.S. Cl. 705/36 R

(57) ABSTRACT

Methods and apparatuses, including computer program products, are described for assigning a risk profile to a guarantee product and charging associated fees. Risk profiles are established, each based on a risk level. A first risk profile is assigned to the guarantee product based on an initial allocation of assets in a linked investment account. A periodic determination is made as to whether the guarantee product is in compliance with the first risk profile due to initial asset allocation changes, including determining whether the asset allocation satisfies the risk level of the first risk profile. A second risk profile is assigned whenever the guarantee product is no longer in compliance with the first risk profile based on the current allocation of assets.

### FIELD OF THE INVENTION

The subject matter of this application relates generally to methods and apparatuses, including computer program products, for assigning a risk profile to a guarantee product, adjusting the fees for the guarantee product based on the risk profile, and charging fees associated with the guarantee product.

### BACKGROUND OF THE INVENTION

Insurance companies have traditionally offered insurance products which allow customers to receive a schedule of payments at a later date in exchange for a purchase of the product. Often, the future schedule of payments is guaranteed by the insurance company, provided that specific criteria and requirements of the product are met. These products can take many forms, such as annuity products standalone living benefit products, and other similar products. The guarantees can take many forms, including guaranteed minimum death benefits, income benefits, withdrawal benefits, lifetime withdrawal benefits, account value guarantees (e.g., GMAB), and other similar guarantees.

An insurance company may offer a product that provides a guaranteed benefit to investors, where the product is linked to an investment account (e.g., 401(k) account, IRA account, or mutual fund account) held by the investor. These investment accounts can have an allocation of assets across different investment types, from conservative investments such as cash and government securities to more risky investments such as international stocks and small company equities. The product may be in the form of a certificate that provides guaranteed benefit payments for a particular time period, such as over the life of the investor (and, in some cases, his or her spouse), if a specified event occurs, such as if the assets in the linked investment account are depleted, and subject to certain conditions.

In order to manage the risk associated with providing such guaranteed benefits, the insurance company imposes significant restrictions on the allocation of assets that are permissible in the linked investment account. Frequently, the investor must maintain a prescribed allocation of assets in his or her investment account. If the allocation of assets falls outside of the prescribed requirements due to, e.g., fluctuations in the economic marketplace, the insurance company may notify the investor and force the investor to rebalance the asset allocation in the investment account to meet the product requirements, or in some cases the insurance company may assess penalties against the investment account, including the potential cancellation of the underlying policy. In some cases, due to degrees of risk associated with a range of asset allocation offerings, the insurance company has no flexibility to offer its customers different types of asset allocation. Instead, the insurance company forces a single asset allocation on its customers to manage risk in a reasonable way.

In the above scenario, the insurance company will likely own or manage the investment account that is linked to the product, or have a certain element of control over the asset allocation in the investment account. Recently, investors have desired to purchase products with guaranteed benefit payments for accounts that are not within the control of the insurance company that offers the product. In these cases, the insurance company is not always able to force the investor to rebalance the asset allocation, leading to an increase in the risk assumed by the insurance company. Furthermore, when the investment account is not in compliance with the product requirements, the insurance company has to initiate the notice and penalty phases described above—resulting in additional maintenance and administration costs to both the insurance company and the investor.

Also, the insurance company usually charges fees associated with the continued maintenance of the product to the investor by deducting the fee amount from the investment account. In doing so, the cost to the insurance company for providing the guarantee goes up because the value of the investment account is reduced; thereby increasing the chance that the insured event occurs, such as the investment account becomes depleted, and the insurance company must begin the guarantee payments.

### SUMMARY OF THE INVENTION

In general overview, the techniques described herein are related to assigning a risk profile to a guarantee product, adjusting fees associated with the guarantee product based on the assigned risk profile, and paying the fees from an account that is not the investment account linked to the guarantee product. The techniques provide the advantages of reducing the risk assumed by an insurance company by increasing the asset allocation compliance of investment accounts that are linked to guarantee products and lessening the administrative costs associated with ensuring such compliance. The techniques also provide the advantage of providing investors with a flexible mechanism to adjust the risk of their investments without incurring penalties or forced rebalancing of the investment account, while also changing the fees assessed to the investor based on the adjusted risk. The techniques also provide the advantage of maintaining a higher asset value in the investment account by deducting the fees associated with the guarantee product from another account, thereby allowing the insurance company to offer the guarantee at a reduced cost.

The invention, in one aspect, features a computerized method for assigning a risk profile to a guarantee product. A computing device establishes a plurality of risk profiles each based on a risk level. The computing device assigns a first risk profile to the guarantee product based on an initial allocation of assets in an investment account linked to the guarantee product. The computing device periodically determines whether the guarantee product is in compliance with the first risk profile due to changes in the initial allocation of assets, including determining whether the allocation of assets in the investment account satisfies risk level of the first risk profile. The computing device assigns a second risk profile to the guarantee product based on a current allocation of assets in the investment account whenever the guarantee product is no longer in compliance with the first risk profile based on the current allocation of assets.

The invention, in another aspect, features a system for assigning a risk profile to a guarantee product. The system includes a computing device configured to establish a plurality of risk profiles each based on a risk level, and assign a first risk profile to the guarantee product based on an initial allocation of assets in an investment account linked to the guarantee product. The computing device is further configured to periodically determine whether the guarantee product is in compliance with the first risk profile due to changes in the initial allocation of assets, including determining whether the allocation of assets in the investment account satisfies the risk level of the first risk profile, and assign a second risk profile to the guarantee product based on a current allocation of assets in the investment account whenever the guarantee product is no longer in compliance with the first risk profile based on the current allocation of assets.

The invention, in another aspect, features a computer program product, tangibly embodied in a non-transitory computer readable storage medium, for assigning a risk profile to a guarantee product. The computer program product includes instructions operable to cause a computing device to establish a plurality of risk profiles each based on a risk level, and assign a first risk profile to the guarantee product based on an initial allocation of assets in an investment account linked to the guarantee product. The computer program product further includes instructions operable to cause the computing device to periodically determine whether the guarantee product is in compliance with the first risk profile due to changes in the initial allocation of assets, including determining whether the allocation of assets in the investment account satisfies the risk level of the first risk profile, and assign a second risk profile to the guarantee product based on a current allocation of assets in the investment account whenever the guarantee product is no longer in compliance with the first risk profile based on the current allocation of assets.

The invention, in another aspect, features a computerized method for charging of fees associated with a guarantee product. A computing device calculates a fee associated with the guarantee product, wherein the guarantee product is linked to a first investment account. The computing device deducts the calculated fee from a second account if deduction of the fee from the second account can be completed. The computing device deducts the calculated fee from the first investment account if deduction from the second account cannot be completed, and a guarantee associated with the guarantee product is adjusted based on deduction of the calculated fee from the first investment account.

The invention, in another aspect, features a computerized method for charging of fees associated with a guarantee product. A computing device calculates a fee associated with the guarantee product, wherein the guarantee product is linked to a first investment account. The computing device deducts the calculated fee from a second account if the deduction from the second account can be completed. The computing device deducts the calculated fee from one or more other accounts if the deduction from the second account cannot be completed. The computing device deducts the calculated fee from the first investment account if the deduction from the one or more other accounts cannot be completed, and a guarantee associated with the guarantee product is adjusted based on deduction of the calculated fee from the first investment account.

In some embodiments, any of the above aspects can include one or more of the following features. In some embodiments, the risk level is based on a ratio of equity assets to total assets in the investment account. In some embodiments, each risk profile includes one or more asset categories defined by a minimum investment percentage and a maximum investment percentage. In some embodiments, the step of determining whether the allocation of assets in the investment account satisfies the risk level of the first risk profile includes determining whether the allocation of assets in the investment account satisfies the minimum investment percentage and the maximum investment percentage for each of the asset categories in the first risk profile.

In some embodiments, the computing device compares the allocation of assets in the investment account with the risk level of the first risk profile to produce a comparison value, and determines whether the comparison value satisfies a tolerance threshold. In some embodiments, the computing device transmits a notice to an owner of the guarantee product whenever the comparison value exceeds the tolerance threshold. In some embodiments, the computing device reallocates the assets in the investment account to bring the guarantee product into compliance with the first risk profile whenever the comparison value exceeds the tolerance threshold. In some embodiments, the computing device transmits a notice to an owner of the guarantee product when the second risk profile is assigned. In some embodiments, the computing device transmits a notice to an owner of the guarantee product whenever the guarantee product is no longer in compliance with the first risk profile due to changes in the initial allocation of assets and before the second risk profile is assigned.

In some embodiments, the computing device reallocates the assets in the investment account to bring the guarantee product into compliance with the first risk profile whenever the guarantee product is no longer in compliance with the first risk profile due to changes in the initial allocation of assets. In some embodiments, the computing device transmits a notice to an owner of the guarantee product whenever the guarantee product is no longer in compliance with the first risk profile and the current allocation of assets in the investment account does not satisfy the risk level of any of the risk profiles.

In some embodiments, the computing device assesses a penalty against the guarantee product whenever the guarantee product is not in compliance with any of the risk profiles on a predetermined date after the notice is transmitted. In some embodiments, the penalty includes termination of the guarantee product, reallocation of the assets in the investment account to bring the guarantee product into compliance with at least one risk profile, reduction of the guarantee associated with the guarantee product, or a fee charged to the guarantee product. In some embodiments, the computing device assigns a third risk profile to the guarantee product based on a current allocation of assets in the investment account if the guarantee product is no longer in compliance with the first risk profile or the second risk profile based on the current allocation of assets.

In some embodiments, the plurality of risk profiles is each associated with a fee amount and the computing device calculates a fee to be charged to the guarantee product based on the fee amount associated with the first risk profile, charges the calculated fee to the guarantee product, and adjusts the calculated fee amount charged to the guarantee product whenever the assigned risk profile changes, the adjusted fee based on the fee amount associated with the newly-assigned risk profile.

In some embodiments, the guarantee product includes at least one of a deferred or immediate fixed or variable annuity, a contingent deferred annuity, or a standalone living benefit. In some embodiments, the guarantee associated with the guarantee product includes at least one of a guaranteed minimum death benefit, an income benefit, a withdrawal benefit, a lifetime withdrawal benefit, or an account value guarantee. In some embodiments, a cash account is established within the investment account, the guarantee applies only to the non-cash account portion of the investment account, and a fee associated with the guarantee product is deducted from the cash account. In some embodiments, a second investment account is established within the investment account and the guarantee does not apply to the second investment account.

In some embodiments, the computing device deducts the calculated fee from one or more other accounts if the deduction from the second account cannot be completed and before deducting the calculated fee from the first investment account, deducts the calculated fee from the first investment account if the deduction from the one or more other accounts cannot be completed, and adjusts the guarantee associated with the guarantee product based on deduction of the calculated fee from the first investment account. In some embodiments, the computing device transmits a notice to an owner of the second account if the deduction from the second account cannot be completed and before deducting the calculated fee from the first investment account. In some embodiments, the computing device transmits a notice to an owner of the second account if the deduction from the second account cannot be completed and after deducting the calculated fee from the first investment account, and adjusts the guarantee associated with the guarantee product based on deduction of the calculated fee from the first investment account. In some embodiments, the computing device receives payment of the calculated fee from the owner of the second account, and reverses the adjustment made to the guarantee associated with the guarantee product.

In some embodiments, the second account is a cash account, a money market account, a bank account, a checking account, a savings account, a mutual fund account, an investment account, a brokerage account, or a trust account. In some embodiments, the one or more other accounts include a cash account, a money market account, a bank account, a checking account, a savings account, a mutual fund account, an investment account, a brokerage account, or a trust account. In some embodiments, the deduction from the second account cannot be completed due to at least one of: insufficient funds available in the second account, a rejection of the deduction from a financial institution managing the second account, and a transaction error resulting from initiation of the deduction. In some embodiments, the computing device transmits an invoice for the calculated fee to an owner of the second account if the deduction from the second account cannot be completed and before deducting the calculated fee from the first investment account, and receives payment for the calculated fee from the owner of the second account. In some embodiments, payment for the calculated fee is received via a manual funds transfer. In some embodiments, the manual funds transfer includes at least one of payment by check, wire transfer, Automated Clearing House (ACH) transfer, payment by credit card, payment by debit card, or payment by money order.

Other aspects and advantages of the invention will become apparent from the following detailed description, taken in conjunction with the accompanying drawings, illustrating the principles of the invention by way of example only.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram of a timeline for a guarantee product offered by an insurance company to be linked to an investment account held by an investor.

FIG. 2 is a block diagram of a system for assigning a risk profile to a guarantee product, adjusting the fees for the guarantee product based on the risk profile, and charging fees associated with the guarantee product.

FIG. 3 is a flow diagram of a method for assigning a risk profile to a guarantee product.

FIG. 4 is a flow diagram of a method for performing an action or series of actions whenever the Covered Asset Pool is no longer in compliance with the risk profile assigned to the guarantee certificate.

FIG. 5 is a flow diagram of a method for charging of fees associated with a guarantee product.

FIGS. 6-11 are workflow diagrams of a method for establishing and monitoring risk profiles associated with a guarantee product, assigning risk profiles to the guarantee product, adjusting risk profiles associated with the guarantee product, and calculating and charging fees associated with the guarantee product.

### DETAILED DESCRIPTION

The techniques described herein provide the advantage of eliminating the requirement of a guarantee product owner to rebalance the asset allocation in an investment account linked to the guarantee product according to a pre-determined time schedule (or at all). The techniques provide the advantage of giving the owner additional freedom to invest as he or she deems appropriate without having to change products or modify the risk category they are invested in, should their needs change. The invention protects the guarantor by charging for the risk appropriately if the asset mix should change from what the owner originally invested in. The invention saves the guarantor from the expense and hassle of notification if the investment mix is different than originally planned.

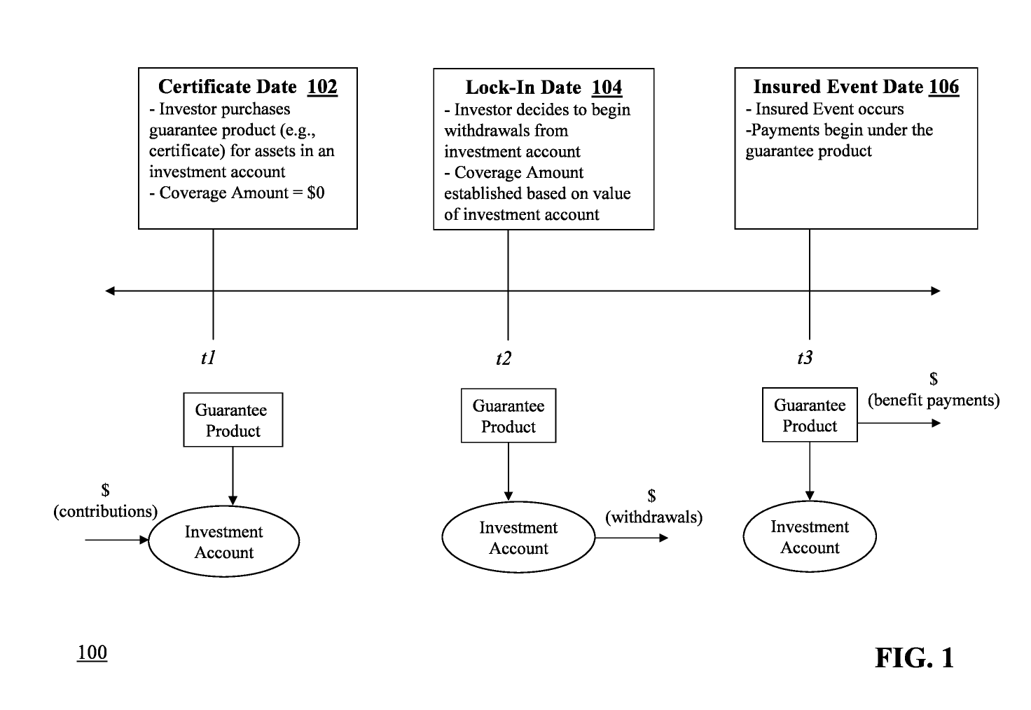

FIG. 1 is a block diagram of a timeline 100 for a guarantee product offered by an insurance company (also called a guarantor) to be linked to an investment account held by an investor. The timeline 100 begins when the investor purchases the product from the guarantor, and ends when the insured event occurs. The guarantee product offered by the guarantor can include an immediate or deferred fixed or variable annuity, a contingent deferred annuity, or a standalone living benefit. The guarantee associated with the guarantee product can include a guaranteed minimum death benefit, an income benefit, a withdrawal benefit, a lifetime withdrawal benefit, or an account value guarantee. The product can take the form of a certificate issued by the guarantor on the assets in the investment account, although other forms of the product are included within the spirit and scope of the invention. For example, the investor may purchase the certificate for protection in the event of potential future withdrawals from the account, sub-par or poor market performance, or both. The certificate provides guaranteed benefit payments over a certain time period if and when an insured event occurs. For example, the time period can be the life of the investor (and, if applicable, his spouse under a joint certificate). The insured event occurs at a date after the guarantee product is purchased, and the insured event triggers the stream of benefit payments under the guarantee product. In some embodiments, the insured event is the depletion of the assets in the investment account (also called the “Covered Asset Pool” or “Covered Asset Pool account”) during a defined time period (e.g., the lifetime of the investor (or spouse)), when the depletion occurs other than by an excess withdrawal from the investment account. In some embodiments, an excess withdrawal occurs when the investor withdraws more than the amount covered by the certificate (also called the “Coverage Amount”) during a time period as defined by the certificate. In some embodiments, the defined time period is one year (also called the “Certificate Year”).

In some embodiments, the assets held in the Covered Asset Pool are to comply with requirements set forth by the guarantor issuing the certificate. For example, the assets must be of a certain type and/or the total value of the assets must meet a required minimum value (e.g., $100,000) or a required maximum value (e.g., $1M). In some embodiments, the investor, and optionally his spouse, must be of a particular age when purchasing the certificate (e.g., between 45 and 90). In some embodiments, the age difference between the investor and his spouse must not exceed a maximum value (e.g., 10 years) in order to purchase a joint certificate.

Generally, the certificate provides a guarantee that, under certain specified conditions, and regardless of the investment performance of the Covered Asset Pool and regardless of how long the investor lives, he is able to receive a guaranteed level of income for a certain period of time (e.g., for life, and the life of his spouse under a joint certificate). This income comes first in the form of withdrawals taken from the Covered Asset Pool, and when an insured event occurs (e.g., when the Covered Asset Pool reaches a zero-dollar value), from guaranteed benefit payments that the insurance company pays to the investor.

Continuing with FIG. 1, at time t1, the investor, who owns assets (e.g., cash, stocks, bonds, or other equity instruments) being held in an investment account (e.g., mutual fund, money market account, 401(k), IRA, or other investment vehicle)—the Covered Asset Pool account—purchases a guarantee product (e.g., a certificate) from the guarantor to cover the assets in the investment account. The event at time t1 is also known as the “Certificate Date” (102). For example, the investor may want protection based on potential future withdrawals from the account, sub-par or poor market performance, or both. Once the certificate is purchased, the investor is also known as the “Certificate Owner.”

In some embodiments, a cash account is established within the Covered Asset Pool and the guarantee applies only to the assets in the non-cash account portion of the Covered Asset Pool. For example, assume the investor contributes $100,000 in cash to his investment account at time t1. The investor elects to allocate $90,000 to assets in the investment account and the remaining $10,000 is held in the cash account. In this example, the guarantee only covers the $90,000 associated with the non-cash account portion of the Pool. The $10,000 can be used, e.g., to pay fees levied by the insurance company for providing the guarantee product. In some embodiments, a second investment account is established within the Covered Asset Pool and the guarantee does not apply to the second investment account portion of the Covered Asset Pool. For example, assume the investor contributes $100,000 in cash to his investment account at time t1. The investor elects to allocate $90,000 to assets in the main investment account and the remaining $10,000 is held in assets in the second investment account. In this example, the guarantee only covers the $90,000 in the main investment account portion of the Pool.

At time t2, the investor selects a “Lock-In Date” (104) at which point he is permitted to make withdrawals from the Covered Asset Pool without adjustments to a Coverage Base associated with the guarantee product. And, at time t3, the “Insured Event Date” (106), an “Insured Event” occurs, meaning that the guarantor begins to make benefit payments under the certificate. In some embodiments, the Insured Event occurs when the Covered Asset Pool account has been depleted (i.e., reduced to a zero-dollar value) by transactions other than excess withdrawals. More detail about the timeline 100 is set forth below.

At time t1, the guarantor determines an initial Coverage Base for the certificate. The Coverage Base is an amount used to calculate the initial Coverage Amount for the certificate. On the Certificate Date, the Coverage Base is set equal to the value of the Certificate Owner's Covered Asset Pool. As an example, at time t1, when the Certificate Owner purchases the certificate, he has $100,000 invested in the Covered Asset Pool in the investment account. Therefore, the initial Coverage Base for the certificate on the Certificate Date is $100,000. However, the Coverage Base is not the same as the Covered Asset Pool. The Coverage Base is typically used only in calculating the initial Coverage Amount.

The Coverage Base can increase in certain circumstances. For example, after the Certificate Date at time t1 and before the Lock-In Date at time t2, the Coverage Base is increased by any subsequent contributions to the Certificate Owner's Covered Asset Pool and is decreased for any withdrawals. In some embodiments, subsequent contributions are permitted until the Lock-In Date and, after the Lock-In Date at time t2, subsequent contributions are no longer permitted. In some embodiments, the Certificate Owner can make additional contributions after the Lock-In Date, with a corresponding adjustment to the Coverage Amount. In some embodiments, the sum of the initial contribution and any subsequent contributions may not exceed the maximum total contributions specified by the certificate. In some embodiments, subsequent contributions do not include dividends or other distributions reinvested in the Covered Asset Pool.

For example, assume that the Coverage Base and Covered Asset Pool are both $100,000, and that the Certificate Owner then makes a contribution of $25,000. Upon making the Contribution, the Coverage Base and the Covered Asset Pool increases to $125,000. Assume that on the next Certificate Anniversary, the value of the Covered Asset Pool has decreased to $120,000, e.g., due to market declines. The Coverage Base remains $125,000. Assume that during the following Certificate Year, the Covered Asset Pool is still at $120,000 and the Certificate Owner makes a contribution of $5,000. The Coverage Base increases to $130,000, even though the Covered Asset Pool increases only to $125,000. Assume that on the following Certificate Anniversary, the Covered Asset Pool has increased to $135,000, due to market gains and that this value represents the highest value of the four prior three-month periods. The Coverage Base increases to $135,000.

In some embodiments, the Coverage Base decreases whenever the Certificate Owner makes an excess withdrawal before the Lock-In Date. Prior to the Lock-In Date, an excess withdrawal is the full amount of any withdrawal (because the Coverage Amount is zero before the Lock-In Date). An excess withdrawal prior to the Lock-In Date reduces the Coverage Base by the greater of (1) the excess withdrawal amount, or (2) a pro rata amount in proportion to the reduction in the value of the Covered Asset Pool. More specifically, prior to the Lock-In Date an excess withdrawal reduces the Coverage Base by the greater of (1) or (2):

(1) is the excess withdrawal amount; and

(2) is the result of c multiplied by d and divided by e (i.e., (c×d)/e)

where:

c=the excess withdrawal amount;

d=the value of the Covered Asset Pool before the excess withdrawal; and

e=the Coverage Base prior to the withdrawal.

For example, assume, before the Lock-In Date, that the Coverage Base is $100,000, and that the value of the Covered Asset Pool is $90,000 on the withdrawal date. Assume that the Certificate Owner withdraws $1,000 in a Certificate Year. Because the Coverage Amount is zero prior to the Lock-In Date, the Certificate Owner has made an excess withdrawal of $1,000. The excess withdrawal ($1,000) multiplied by the Coverage Base before the excess withdrawal ($100,000), and then divided by the value of the Covered Asset Pool ($90,000):

($1,000×$100,000)/($90,000)=$1111.11

$1111.11 is greater than the excess withdrawal of $1,000. Therefore, the Coverage Base is reduced by $1111.11. The new Coverage Base is $98,888.89.

Also, at time t1, the “Coverage Amount” of the certificate is $0. The “Coverage Amount” is the amount of withdrawals permitted each period (e.g., each Certificate Year) after the Lock-In Date, and the Coverage Amount also equals the amount of the benefit payments guaranteed to be paid to the Certificate Owner each year after the Insured Event occurs (e.g., in the event that the Covered Asset Pool is depleted in accordance with the conditions specified in the certificate). The Coverage Amount is initially calculated when the coverage provided under the certificate begins, by multiplying the “Coverage Percentage” by the “Coverage Base” (as described below). Any withdrawal taken from the Covered Asset Pool during the initial period (e.g., from time t1 to time t2) is considered an excess withdrawal. Such withdrawals have the potential to significantly decrease and even terminate the benefits provided by the certificate.

On each Certificate Anniversary before the Lock-In Date, the Certificate Owner's Coverage Base will be the greatest of: 1) the current Coverage Base; 2) the value of the Certificate Owner's Covered Asset Pool on the Certificate Anniversary; or 3) if there have been no withdrawals during the preceding Certificate Year, the value of the Certificate Owner's Covered Asset Pool as of any specified time period (e.g., a three-month period) during the immediately preceding Certificate Year. If the Certificate Owner's Coverage Base increases pursuant to 2 or 3, the increase is treated as an automatic step-up. The fee percentage assigned to the certificate (the “Certificate Fee Percentage”) may increase due to an automatic step-up of the Coverage Base (unless the step-up is rejected by the Certificate Owner). In some embodiments, the Certificate Fee Percentage never exceeds a predetermined maximum amount.

At time t2, the Certificate Owner selects (104) a “Lock-In Date” at which point he can make withdrawals from the Covered Asset Pool up to the Coverage Amount without the withdrawals being considered as excess withdrawals. In some cases, the Certificate Owner can make withdrawals above the Coverage Amount during a particular period specified in the certificate (e.g., one Certificate year or one calendar year), but the Certificate Owner may be penalized for doing so, in the form of an excess withdrawal fee, a reduction in his Coverage Amount, or both. In some embodiments, contributions to the Covered Asset Pool account are no longer allowed after the Lock-In Date. In some embodiments, the Lock-In Date is no earlier than the date the Certificate Owner (or where joint coverage is selected, the date the younger spouse) attains a specific age (e.g., age 60). In some embodiments, the Coverage Percentage is determined by (i) the Certificate Owner's attained age (i.e., age at last birthday) (or for a joint certificate, the age of the younger spouse) at the Lock-In Date, and (ii) a specified benchmark value, such as the current 10-year United States Treasury Bond Yield. In some embodiments, the Coverage Percentage has a cap and/or a floor. For example, the Coverage Percentage can range from a floor of 4% to a cap of 8%. Before the Insured Event occurs (e.g., the Covered Asset Pool is depleted), the Coverage Amount is also the maximum amount that the Certificate Owner may withdraw in one Certificate Year without causing an excess withdrawal.

For example, the Certificate Owner purchases a certificate at age 65 and the Coverage Base on the Lock-In Date is $100,000. This means that the initial Coverage Amount equals $100,000 multiplied by the applicable Coverage Percentage. Assume that the applicable Coverage Percentage is 5.0%. Then, the initial Coverage Amount equals $5,000. Therefore, before the Insured Event, the Certificate Owner may withdraw $5,000 annually (i.e., each Certificate Year) from the Covered Asset Pool without reducing the benefits guaranteed to him under the certificate. If the Insured Event occurs (and all other conditions are satisfied, if any), then the guarantor pays the Certificate Owner $5,000 annually (in monthly or other periodic payments) for a certain time period. In some embodiments, the payments are made until the Certificate Owner's death. In some embodiments, the payments are made for a specific number of time intervals (e.g., months or years).

After the Lock-In Date at t2 104, but before the Insured Event Date at t3 106, the Coverage Amount is calculated on each Certificate Anniversary (i.e., the anniversary of the date on which the certificate was purchased). On each Certificate Anniversary after the Lock-In Date, the Certificate Owner's Coverage Amount will be the greater of: 1) the current Coverage Amount; or 2) the current value of the Covered Asset Pool on the Certificate Anniversary multiplied by the current Coverage Percentage as determined by the Certificate Owner's attained age (e.g., age at last birthday) (or for a joint certificate, the age of the younger spouse) at the Lock-In Date and a benchmark value (e.g., the current 10-year United States Treasury Bond Yield). If the Certificate Owner's Coverage Amount increases pursuant to 2, the increase is treated as an automatic step-up. The Certificate Fee Percentages may increase (or decrease) due to an automatic step-up of the Coverage Amount (unless the step-up is rejected by the Certificate Owner).

For example, assume the initial Coverage Amount equals $5,000. On a Certificate Anniversary the value of the Covered Asset Pool is $95,000. Assume that the Coverage Percentage, based on a benchmark such as the 10-year United States Treasury Bond Yield and the Certificate Owner's age at the Lock-In Date, is 5.5%. Therefore, on that Certificate Anniversary, the Coverage Amount is recalculated as $5,225. (5.5% of $95,000 equals $5,225.) Accordingly, before the Insured Event, the Certificate Owner may withdraw $5,225 annually (i.e., each Certificate Year) from the Covered Asset Pool without reducing the guaranteed benefits. If the Insured Event occurs (and all other conditions are satisfied, if any), then the guarantor pays the Certificate Owner $5,225 annually (in monthly or other periodic payments) for a specific time period, such as until the Certificate Owner's death.

In some embodiments, any withdrawals made above the Coverage Amount in any Certificate Year result in a decrease of the benefits provided by the certificate, and in some cases, result in termination of the benefits provided by the certificate. Also, in some embodiments, if the Certificate Owner does not withdraw the entire Coverage Amount in any Certificate Year, the “unused” amount is not carried over to the next year.

In some embodiments, the Coverage Amount decreases whenever the Certificate Owner makes an excess withdrawal. After the Lock-In Date, an excess withdrawal occurs if the Certificate Owner withdraws more than the Coverage Amount in any Certificate Year (or an optional additional Coverage Amount in any calendar year). As described above, in some embodiments, Coverage Amounts are based on Certificate Years, and not on calendar years. The excess withdrawal is the amount withdrawn in excess of the Coverage Amount. In addition, dividends, capital gains, and other distributions from Covered Assets that are not reinvested can be treated as withdrawals.

In some embodiments, an excess withdrawal after the Lock-In Date reduces the Coverage Amount on a pro rata basis in proportion to the reduction in the value of the Covered Asset Pool. Therefore, after the Lock-In Date, an excess withdrawal can reduce the Coverage Amount by a dollar amount that is greater than the amount of the excess withdrawal. Excess withdrawals may reduce and even eliminate the benefits of the certificate. More specifically, after the Lock-In Date an excess withdrawal reduces the Coverage Amount according to the following formula: f multiplied by g and divided by h (i.e., (f×g)/h) where:

f=the excess withdrawal amount (i.e., the amount withdrawn in excess of the Coverage Amount that remained before the withdrawal);

g=the value of the Covered Asset Pool after the Coverage Amount has been withdrawn, but before the excess withdrawal; and

h=the Coverage Amount prior to the withdrawal.

For example, assume that the Coverage Base is $100,000 and the Coverage Amount is $5,000. Assume that the Certificate Owner initially withdraws $3,000 in a Certificate Year. This amount is below the Coverage Amount of $5,000, so there is no excess withdrawal. Assume that in the same Certificate Year, the Certificate Owner later withdraws an additional $3,000 and that prior to this withdrawal, the value of the Covered Asset Pool was $97,000. When added to the previous Withdrawal of $3,000, the Certificate Owner has made an excess withdrawal of $1,000.

The excess withdrawal ($1,000) multiplied by the Coverage Amount prior to the withdrawal ($5,000) divided by the value of the Covered Asset Pool ($97,000) after the remaining Coverage Amount ($2,000) is withdrawn:

($1,000×$5,000)/($97,000−$2,000)=$52.63

Therefore, the Coverage Amount is reduced by $52.63. The new Coverage Amount is $4,947.37.

At time t3, the Insured Event occurs (106), which triggers the initiation of benefit payments by the guarantor. In some embodiments, the Insured Event occurs when the Covered Asset Pool has been depleted (i.e., reduced to a zero-dollar value) by transactions other than excess withdrawals. Generally, no benefits are paid until the Insured Event occurs.

In some embodiments, additional conditions must be met before the benefit payments begin. For example, if the Insured Event occurs and all of the following are true, then the Certificate Owner is entitled to benefit payments under the Certificate:

(1) The certificate is in force;

(2) The Lock-In Date has been established;

(3) The Certificate Owner (or his or her spouse under a joint certificate) is alive;

(4) The Coverage Amount is greater than zero;

(5) All fees due under the certificate are paid;

(6) Any other conditions of the certificate (and/or contract between the guarantor and Certificate Owner, if applicable) are met.

If the above are true, then the guarantor pays the Certificate Owner the Coverage Amount each Certificate Year (after the Certificate Year in which the Insured Event occurs, for which the guarantor pays any remaining Coverage Amount). For example, assume the Certificate Owner had a Coverage Amount of $5,000 and he had taken $3,200 in standard withdrawals during the current Certificate Year. Then, the Insured Event occurred; in this example, the remaining value of the Covered Asset Pool was reduced to zero due to a market downturn. The guarantor would make an initial benefit payment of $1,800—the Coverage Amount minus the previous withdrawal. In the next Certificate Year, the guarantor makes a payment equal to the full Coverage Amount of $5,000.

In some embodiments, the benefit payments are divided into monthly (or other periodic) payments, as elected by the Certificate Owner and agreed to by the guarantor. The payments are paid to the Certificate Owner for a specific time period, such as until his or her death (or the death of his or her spouse, if later, under a joint certificate).

As mentioned above, the certificate is subject to fees charged by the guarantor for providing the benefits under the certificate. The “Certificate Fee” (i.e., the fee paid by the Certificate Owner for the benefits provided under the certificate) is calculated and due on the Certificate Date and thereafter at specific time periods (e.g., each three-month period). In some embodiments, the guarantor transmits a notice to the Certificate Owner if the fee is not paid as of the due date. If the fee is not paid within a predetermined time period from the due date, the guarantor may elect to terminate the certificate and the corresponding payment of benefits is eliminated.

The guarantor can impose limitations or restrictions on the allocation of assets in the Covered Asset Pool in order to manage the risk associated with providing the guarantee. For example, the guarantor may wish to limit the amount of moderate-to-high risk investments in the Covered Asset Pool account in order to lower the chance that the Insured Event occurs, such as the chance that the Pool is depleted during the life of the Certificate Owner. One approach to managing the risk is to assign a risk profile to the Covered Asset Pool. The risk profile defines the overall asset allocation of the Covered Asset Pool, including rules associated with specific asset categories within the Pool. A plurality of risk profiles with different asset allocation rules can be created to account for varying levels of risk.

In some embodiments, the guarantor can assign an initial risk profile based on the initial allocation of assets in the Covered Asset Pool. In some embodiments, the investor can select a desired risk profile and the guarantor can ensure that asset allocation of the investor's Covered Account Pool complies with the selected risk profile. Based on fluctuations in the market, or other events such as withdrawals, contributions, and manual reallocation of assets, the asset allocation in the Covered Asset Pool account may diverge from its original make-up and no longer be in compliance with the asset allocation rules identified by the initial risk profile—leading to an increase (or decrease) in the risk level. The guarantor can assign a new risk profile to the Covered Asset Pool based on the changes in the asset allocation without requiring notification of the Certificate Owner and avoiding potential penalty phases, thereby reducing the maintenance and administration costs for the guarantor and decreasing the chance that the guarantee product could be cancelled due to violation of the risk profile.

In addition, the guarantor can assess different levels of fees for each of the risk profiles. For example, a Certificate Owner that opts to allocate his assets according to a high-risk profile may pay a higher Certificate Fee than another Certificate Owner that allocates her assets to match a low-risk profile. Using the above example, the guarantor can automatically adjust the fees when assigning a new risk profile to the Covered Asset Pool based on changes to the asset allocation. The following paragraphs discuss the risk profiles and adjustment of fees in greater detail.

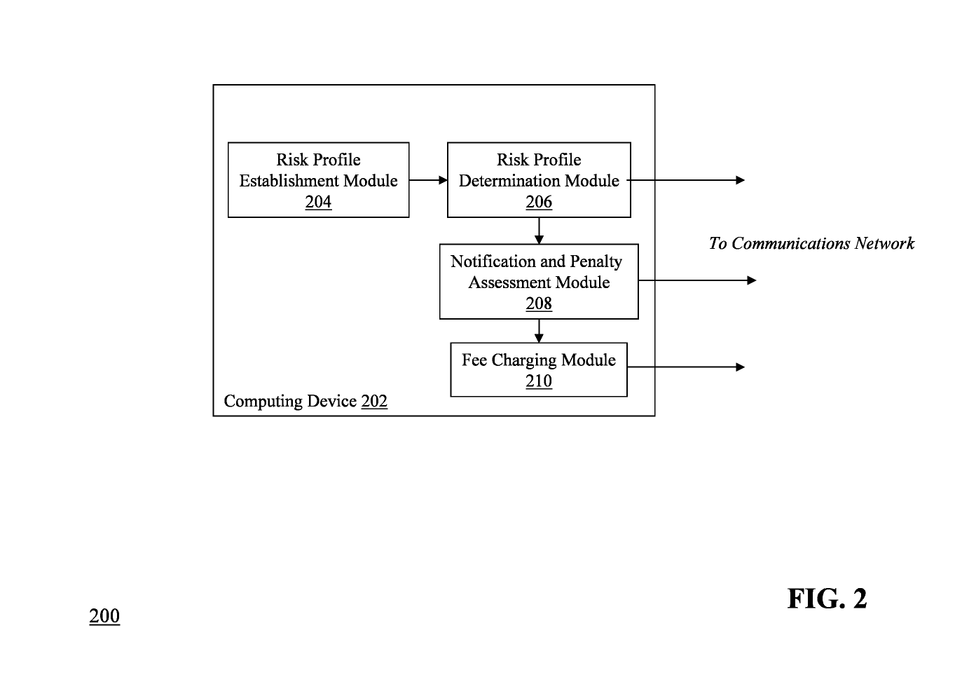

FIG. 2 is a block diagram of a system 200 for assigning a risk profile to a guarantee product, adjusting the fees for the guarantee product based on the risk profile, and charging fees associated with the guarantee product. The system 200 includes a computing device 202 for implementing the computer processing in accordance with a computer-implemented embodiment of the present invention. The methods described herein may be presented in terms of program procedures executed on, for example, a computer or network of computers. The computing device 202 includes a risk profile establishment module 204, a risk profile determination module 206, a notification and penalty assessment module 208, and a fee charging module 210. The risk profile establishment module 204, risk profile determination module 206, notification and penalty assessment module 208, and fee charging module 210 are hardware and/or software modules located in the computing device 202 and used to execute the methods for assigning a risk profile to a guarantee product, adjusting the fees for the guarantee product based on the risk profile, and charging fees associated with the guarantee product as described herein. In some embodiments, the computing device 202 is a server computing device located on a communication network (e.g., Internet, WAN, or LAN) and communicating with other computing devices (not shown). In some embodiments, the functionality of the risk profile establishment module 204, risk profile determination module 206, notification and penalty assessment module 208, and fee charging module 210 is distributed among a plurality of computing devices. It should be appreciated that any number of computing devices, arranged in a variety of architectures, resources, and configurations (e.g., cluster computing, virtual computing, cloud computing), can be used without departing from the spirit or scope of the invention.

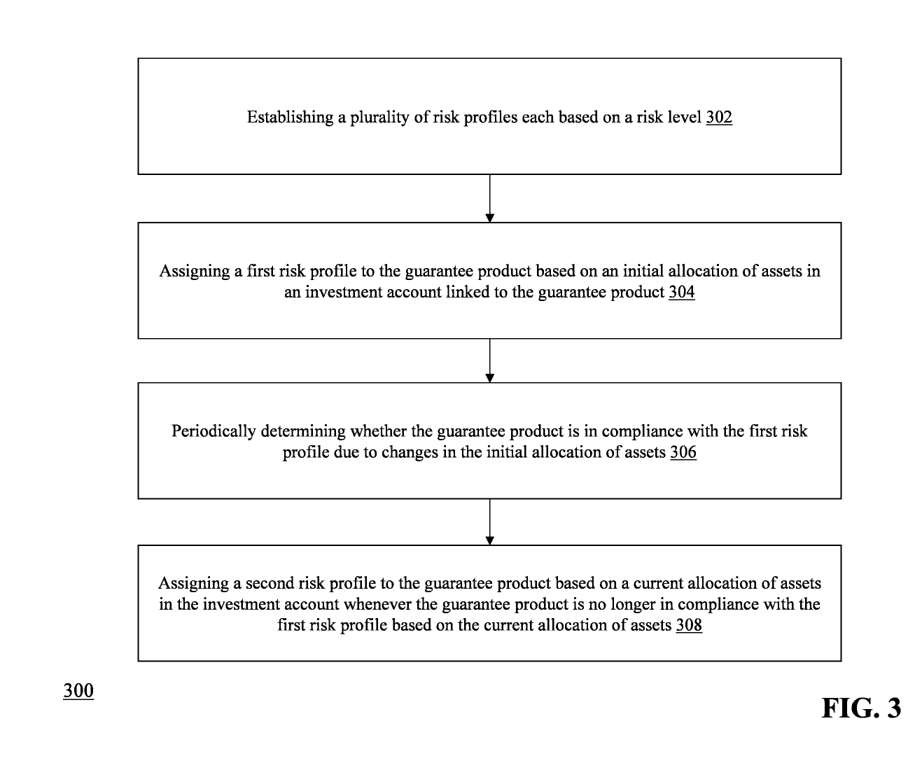

FIG. 3 is a flow diagram of a method 300 for assigning a risk profile to a guarantee product, using the system 200 of FIG. 2. The computing device 202 establishes (302) a plurality of risk profiles each based on a risk level. The risk level is a metric used by the computing device 202 to evaluate the degree of risk associated with the allocation of assets in a particular investment vehicle (e.g., the Covered Asset Pool). In some embodiments, the risk level is based on a ratio of equity assets to total assets in the Covered Asset Pool account. It should be appreciated that other metrics and measurements of risk in an investment account or asset portfolio can be used as the risk level without departing from the spirit or scope of the invention. The risk profiles include predefined rules for the allocation of assets in the Covered Asset Pool account according to a known or expected risk of the investments.

In some embodiments, each risk profile is defined to include one or more asset categories that have a minimum investment percentage and a maximum investment percentage. The risk level (e.g., ratio of equity assets to total assets) relates to the overall asset allocation in an investment account that is linked to the guarantee product. The aforementioned ratio of equity assets to total assets can be expressed as a percentage (e.g., 55% equity). The minimum investment percentage and the maximum investment percentage relate to the asset allocation in the investment account for each of the individual asset categories.

Asset categories relate to the type of assets held in the investment account. There may be a number of different asset categories based on the risk associated with the asset type. In some embodiments, asset categories range from low to high risk. In the present embodiment, the asset categories include Core Fixed, Core Equity, International, Small/Mid Cap, and Alternative, with Core Fixed being the lowest risk and Alternative being the highest risk. The techniques described herein are not limited to these asset categories, and any number of asset categories can be defined and used in accordance with the techniques.

Table 1 below provides a definition for example risk profiles and their associated overall asset allocation rules:

| | Risk Level (expressed as ratio of Equity |
|---|---|
| Risk Profile | assets to Total Assets) |
| A | Aggregate value of non-Core Fixed assets |
| | cannot exceed 50% of the total asset |
| | value of the Covered Asset Pool |
| B | Aggregate value of non-Core Fixed assets |
| | is greater than 50% but not more than 60% |
| | of the total asset value of the Covered Asset Pool |
| C | Aggregate value of non-Core Fixed assets |
| | is greater than 60% but not more than 70% |
| | of the total asset value of the Covered Asset Pool |
| D | Aggregate value of non-Core Fixed assets |
| | is greater than 70% but not more than 80% |
| | of the total asset value of the Covered Asset Pool |

As shown in Table 1, Risk Profile A requires that the Covered Asset Pool account maintain at least 50% of its asset value in the Core Fixed asset category, while allowing up to 50% of the asset value in the Covered Asset Pool to be invested in non-Core Fixed assets. The Core Fixed category is generally a low-risk investment option. Risk Profile B allows for between 50% and 60% of the asset value in the Covered Asset Pool to be invested in non-Core Fixed assets, Risk Profile C allows for between 60% and 70%, and Risk Profile D allows for between 70% and 80%. It should be appreciated that any number of different risk profiles, including but not limited to those described herein, can be defined without departing from the spirit and scope of the invention.

Table 2 below provides an example of asset categories available to each risk profile, and the minimum investment percentage and maximum investment percentage for each asset category. The asset categories and associated percentages can be the same across each risk profile, or different risk profiles can have different combinations of asset categories with varying minimum and maximum investment percentages.

| Asset Category | Min. Investment % | Max. Investment % |
|---|---|---|
| Core Fixed | 20 | 100 |
| Core Equity | 0 | 80 |
| International | 0 | 25 |
| Small/Mid Cap | 0 | 10 |
| Alternative | 0 | 5 |

As shown in Table 2, the asset categories are arranged from low-risk (e.g., Core Fixed) to high-risk (e.g., Alternative). The Core Fixed Asset Category has a minimum investment percentage of 20%, meaning that the Certificate Owner (or his investment advisor) is required to maintain at least 20% of the asset value in the Covered Asset Pool as Core Fixed assets. The Certificate Owner can opt to invest up to 100% of his assets in the Core Fixed category. Each of the other categories—Core Equity, International, Small/Mid Cap, and Alternative—has a minimum investment percentage of 0%, so the Certificate Owner can elect not to invest any of his assets in those categories. Optionally, the Certificate Owner can invest in any or all of the asset categories, up to the maximum investment percentage and assuming that the total asset allocation satisfies (i) each of the asset categories and (ii) the overall asset allocation rule for the Risk Profile as a whole.

At time t1, the Certificate Date 102, when the Certificate Owner purchases the guarantee product (e.g., certificate) for his Covered Asset Pool account, the computing device 202 assigns (304) a first risk profile to the guarantee product based on the initial allocation of assets in the investment account linked to the guarantee product. In some embodiments, the computing device 202 identifies the particular assets held in the investment account and classifies each of the assets into one of the asset categories. The computing device 202 also determines the risk level for the Covered Asset Pool account (e.g., ratio of equity assets to total assets). Based on this information, the computing device 202 selects a risk profile that matches the asset allocation and assigns the risk profile to the certificate. In some embodiments, the computing device 202 receives a selection of a risk profile from the investor and determines whether the asset allocation in the investor's Covered Asset Pool account satisfies the risk level of the selected risk profile. If the risk level is satisfied, the computing device 202 assigns the selected risk profile to the certificate.

For example, Certificate Owner A has the following asset allocation in his Covered Asset Pool account at time t1 102 when he purchases the certificate: 20% Core Fixed; 55% Core Equity; and 25% International. As a result, the risk profile assigned to Certificate Owner A's Covered Asset Pool is Risk Profile D—a high-risk profile—because the Covered Asset Pool has 20% Core Fixed assets and 80% non-Core Fixed assets, and the assets in the Covered Asset Pool fall within the minimum and maximum investment percentages specified for each of the applicable asset categories.

In another example, Certificate Owner B has the following asset allocation in her Covered Asset Pool account at time t1 102 when she purchases the certificate: 75% Core Fixed; 20% Core Equity; and 5% Alternative. As a result, the risk profile assigned to Certificate Owner B's Covered Asset Pool is Risk Profile A—a low-risk profile—because the Covered Asset Pool has 75% Core Fixed assets and 25% non-Core Fixed assets, and the assets in the Covered Asset Pool fall within the minimum and maximum investment percentages specified for each of the applicable asset categories.

Periodically, the computing device 202 determines (306) whether the allocation of assets in the Covered Asset Pool account is still in compliance with the risk profile that was assigned to the guarantee product at time t1 102. As mentioned previously, external effects such as market fluctuation, or internal effects such as contribution of additional assets to the Covered Asset Pool or reallocation of the assets by the investor, can affect both the overall asset allocation in the Pool as well as the particular asset allocation for each of the asset categories within the Pool. In some cases, these effects may cause the allocation of assets to shift out of compliance with the assigned risk profile for the guarantee product. The computing device 202 determines whether the Covered Asset Pool account is still in compliance with the risk profile assigned to the guarantee product by determining whether the allocation of assets in the investment account satisfies the risk level for that risk profile. For example, the computing device 202 can compare the Covered Asset Pool against the risk level of the first risk profile. The computing device 202 also determines whether the allocation of assets in the Covered Asset Pool account satisfies the minimum investment percentage and maximum investment percentage for each of the asset categories of the first risk profile.

In some embodiments, the computing device 202 conducts a determination of risk profile compliance according to a predetermined schedule (e.g., monthly, quarterly) based on the calendar year. In some embodiments, the computing device 202 conducts a determination of risk profile compliance according to a predetermined schedule (e.g., monthly, quarterly) based on the Certificate Year. For example, at the end of a predetermined period, the computing device 202 analyzes the asset allocation in the Covered Asset Pool account and determines whether the asset allocation meets the requirements of the currently-assigned risk profile. If there have been changes to the asset allocation that places the Covered Asset Pool out of compliance with the risk profile, the computing device 202 assigns a new risk profile as discussed in more detail below. The computing device 202 conducts the determination at the end of each schedule period.

In cases where the computing device 202 determines that the Covered Asset Pool account is no longer in compliance with the first risk profile assigned to the guarantee product, the computing device 202 assigns (308) a second risk profile to the guarantee product based on the current allocation of assets in the Covered Asset Pool account. For example, the certificate of Certificate Owner A had previously been assigned Risk Profile D at time t1 102. During the next month, Certificate Owner A decided to contribute additional cash to his investment account and invest the cash in Core Fixed assets—bringing the asset category allocation of his Covered Asset Pool account to 32% Core Fixed; 46% Core Equity; and 21% International. As a result, Certificate Owner A's Covered Asset Pool now has an overall asset allocation of 32% Core Fixed assets and 68% non-Core Fixed Assets. At the end of the month, the computing device 202 determines that Certificate Owner A's Covered Asset Pool no longer complies with Risk Profile D assigned to the certificate because the allocation of assets no longer meets the risk level for Risk Profile D—in this case, the ratio of equity assets to total assets has fallen below 70%. The computing device 202 assigns Risk Profile C to the certificate because the asset allocation in the Covered Asset Pool now satisfies the requirements for Risk Profile C. The particular asset category allocation for Certificate Owner A's Covered Asset Pool still meets the minimum and maximum investment percentages for the individual asset categories.

In another example, the certificate of Certificate Owner B had previously been assigned Risk Profile A at time t1 102. During the next month, Certificate Owner B decided to reallocate the assets in her Covered Asset Pool account to 48% Core Fixed; 50% Core Equity; and 2% Alternative. As a result, Certificate Owner B's Covered Asset Pool now has an overall asset allocation of 48% Core Fixed assets and 52% non-Core Fixed Assets. At the end of the month, the computing device 202 determines that Certificate Owner B's Covered Asset Pool account no longer complies with Risk Profile A assigned to the certificate because the allocation of assets no longer meets the risk level for Risk Profile A—in this case, the ratio of equity assets to total assets has risen above 50%. The computing device 202 assigns Risk Profile B to the certificate because the asset allocation in the Covered Asset Pool now satisfies the overall asset allocation rule for Risk Profile B. The particular asset category allocation for Certificate Owner B's Covered Asset Pool account still meets the minimum and maximum investment percentages for the individual asset categories.

In some embodiments, the computing device 202 establishes a tolerance threshold for use in determining whether the Covered Asset Pool is in compliance with the risk profile assigned to the guarantee product. The tolerance threshold can be a maximum value or range by which asset allocation in the Covered Asset Pool falls outside the risk level and other rules prescribed by the assigned risk profile before the computing device 202 proceeds to assign a new risk profile to the guarantee product. The tolerance threshold can include a plurality of values or ranges. In addition, the computing device 202 can establish a plurality of tolerance thresholds for different aspects of the risk profile. For example, the tolerance threshold for the overall asset allocation ratio can be 1% while the tolerance threshold for the individual asset category investment percentages can be 2%.

For example, assume the tolerance threshold for both the overall asset allocation ratio and the individual asset category minimum and maximum investment percentages is 1%. The computing device compares the current ratio of equity assets to total assets of the Covered Asset Pool (e.g., 51% equity) with the risk level (e.g., ratio of equity assets to total assets) defined in the risk profile (e.g., for Risk Profile A, 50% equity). Because the difference between the current ratio and the ratio defined in the risk profile is 1% and meets the tolerance threshold, the computing device 202 does not determine that the Covered Asset Pool account is no longer in compliance with the risk profile assigned to the guarantee product.

The computing device 202 also compares the asset category allocation in the Covered Asset Pool (e.g., 49% Core Fixed; 44% Core Equity; 6% Alternative) with the minimum investment percentage and maximum investment percentage for each of the asset categories (e.g., 20-100% Core Fixed; 0-80% Core Equity; 0-5% Alternative). Because the percentage of Alternative assets in the Covered Asset Pool (e.g., 6%) is 1% above the maximum investment percentage for that category (e.g., 5%), and meets the tolerance threshold, the computing device 202 does not determine that the Covered Asset Pool account is no longer in compliance with the risk profile assigned to the guarantee product.

In some embodiments, the computing device 202 tracks the number of times that the allocation of assets in the Certificate Owner's Covered Asset Pool is not in compliance with the assigned risk profile but falls within the tolerance threshold. The computing device 202 can determine that, upon meeting or exceeding a specified number of noncompliance events, the computing device 202 initiates a penalty/notice/reallocation phase with respect to the Certificate Owner's guarantee product. The specified number of noncompliance events can be based on a given time period (e.g., monthly or yearly). The specified number of noncompliance events can be based on the total duration that the guarantee product is in effect. The specified number of noncompliance events can be based on a number of consecutive noncompliance events.

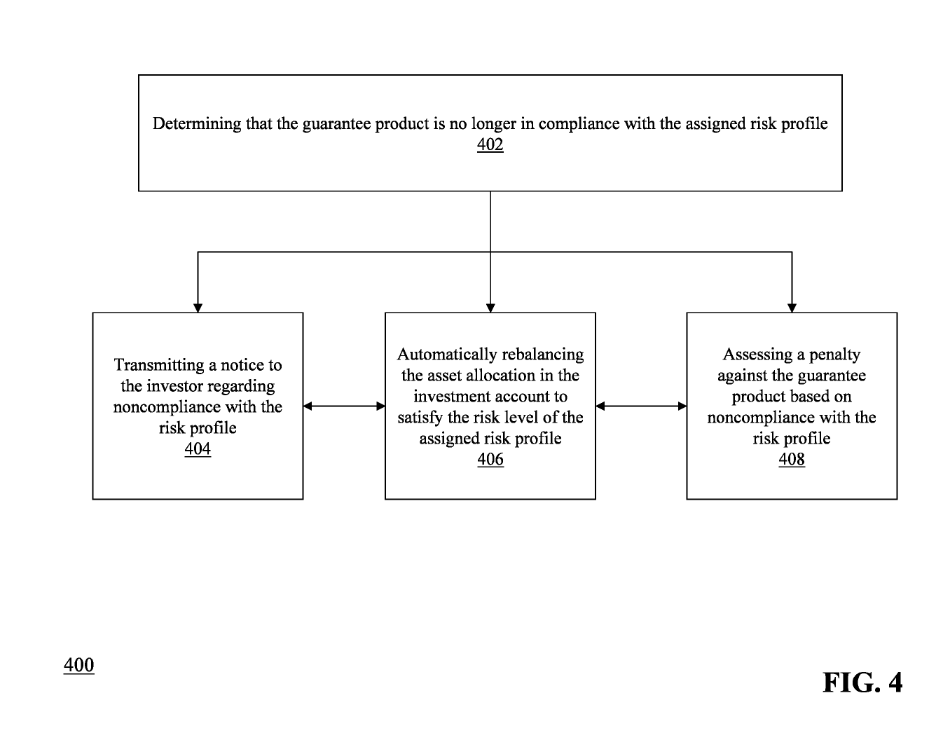

Whenever the computing device 202 determines that the Covered Asset Pool account is no longer in compliance with the risk profile assigned to the guarantee product, the computing device 202 can perform a number of different actions, either individually or in combination with each other. FIG. 4 is a flow diagram of a method 400 for performing an action or series of actions whenever the Covered Asset Pool is no longer in compliance with the risk profile assigned to the guarantee product, using the system 200 of FIG. 2.

The computing device 202 determines (402) that the Covered Asset Pool is not in compliance with the risk profile assigned to the guarantee product. In some embodiments, the computing device 202 transmits (404) a notice to the Certificate Owner indicating that the Covered Asset Pool is no longer in compliance with the currently-assigned risk profile. The notice can establish a predetermined time period in which the Certificate Owner must cure the defect in the Covered Asset Pool account to bring the Pool back into compliance with the assigned risk profile. In some embodiments, the computing device 202 transmits (404) the notice prior to assigning a new risk profile to the guarantee product based on the changed asset allocation in the Covered Asset Pool account. In some embodiments, the computing device 202 transmits (404) the notice after assigning a new risk profile and the notice can indicate that a new risk profile has been assigned.

The computing device 202 can initiate transmission of the notice via any number of communication methods: e-mail, text message, instant message, letter, telephone call, and/or fax. The computing device 202 can perform the transmission of the notice automatically, or interact with other systems to complete the transmission. For example, the computing device 202 can be coupled to an Interactive Voice Response (IVR) system that automatically calls out to the Certificate Owner with the notice. In another example, the computing device 202 can flag the Certificate Owner's policy and/or profile for a customer service representative to view and perform a procedure to contact the Certificate Owner.

In some embodiments, the computing device 202 automatically rebalances (406) or reallocates the assets in the Covered Asset Pool account to achieve compliance with the assigned risk profile whenever the computing device 202 determines (402) that the Covered Asset Pool is no longer in compliance with the risk profile assigned to the guarantee product. For example, the computing device 202 can issue a rebalancing request to the financial institution that manages the Covered Asset Pool.

In some embodiments, the computing device 202 assesses (408) a penalty against the Certificate Owner based on noncompliance of the Covered Asset Pool with the assigned risk profile. The penalty can include any or all of: charging a fee to the Covered Asset Pool account, forced reallocation of assets in the Covered Asset Pool to achieve compliance with the assigned risk profile, adjustment of the guarantee associated with the guarantee product, and termination of the guarantee product. In some embodiments, the computing device 202 does not assess the penalty unless the asset allocation in the Covered Asset Pool is still not in compliance with the assigned risk profile after a certain time period (i.e., a cure period).

In some cases, however, the changes in the asset allocation result in a Covered Asset Pool that is not in compliance with any of the established risk profiles. For example, the certificate of Certificate Owner A had previously been assigned Risk Profile D at time t1 102. During the next month, Certificate Owner A decided to reallocate the assets in his investment account as follows: 14% Core Fixed; 55% Core Equity; 25% International; 6% Small/Mid Cap. At the end of the month, the computing device 202 determines that the current allocation of assets in the Covered Asset Pool is not in compliance with Risk Profile D because the risk level (e.g., ratio of equity assets to total assets) is 86% and the percentage of assets allocated to the Core Fixed category is less than the minimum investment percentage of 20%. The computing device 202 can:
1) automatically rebalance the assets to bring the Covered Asset Pool back into compliance with Risk Profile D (e.g., set the asset allocation to 20% Core Fixed; 49% Core Equity; 25% International; 6% Small/Mid Cap) and, optionally, transmit a notice to the Certificate Owner that his Covered Asset Pool was not in compliance with Risk Profile D and a rebalancing has occurred;
2) transmit a notice to the Certificate Owner that his Covered Asset Pool is not in compliance with Risk Profile D and provide a specified cure period (e.g., 60 days) during which the Certificate Owner must bring the Pool back into compliance with Risk Profile D; and/or
3) assess a penalty against the guarantee product based on noncompliance with Risk Profile D on or after a predetermined date (e.g., after the cure period has ended).

As mentioned above, the guarantee product (e.g., certificate) is subject to fees (e.g., Certificate Fee) charged by the guarantor for providing the guarantee benefits under the product. In some embodiments, the fee is based on a percentage of the Coverage Base and/or the Coverage Amount. In some embodiments, the fee is based on a percentage of the Covered Asset Pool. In some embodiments, the fee is based on a percentage of the difference between the Coverage Base and the Covered Asset Pool. In some embodiments, the fee is based on a predetermined fixed cost or other pre-determined schedule of fees (e.g., escalating fees). In some embodiments, the fee is tied to an external index or a pre-defined formula. It should be appreciated that other methods or criteria used to establish and calculate the fee can be used without departing from the spirit or scope of the invention.

In some embodiments, the Certificate Fee is calculated and due on the Certificate Date and thereafter at specified periods (e.g., each three-month date) after the Certificate Date. In some embodiments, the Certificate Fee is calculated using an applicable annualized fee percentage (“Certificate Fee Percentage”) multiplied by the value of the Certificate Owner's Covered Asset Pool on the calculation date times the number of days in a Certificate Year quarter divided by the number of days in the Certificate Year. More specifically, the Certificate Fee is calculated by multiplying j by k by l, where:

j=the value of the Covered Asset Pool as of the calculation date;

k=the applicable Certificate Fee Percentage; and

l=the number of days in the current Certificate Year quarter divided by the number of days in the Certificate Year.

In some embodiments, the Certificate Fee is no longer applicable upon the occurrence of the Insured Event, such as when the Covered Asset Pool is depleted to a zero-dollar value, or termination of the guarantee product.

The Certificate Fee Percentage is defined by the risk profile currently assigned to the Certificate Owner's certificate and Covered Asset Pool. Generally, the greater the percentage of assets in the Certificate Owner's Covered Asset Pool allocated to assets outside of the Core Fixed category, the higher the Certificate Fee Percentage.

Table 3 below provides an example of Certificate Fee Percentages applicable to each of the risk profiles:

| Risk Profile | Initial Certificate Fee % | Maximum Certificate Fee % |
|---|---|---|
| A | 1.00 | 1.75 |
| B | 1.15 | 1.90 |
| C | 1.35 | 2.10 |
| D | 1.75 | 2.50 |

As an example, assume the Covered Asset Pool of Certificate Owner A has a value of $100,000, there are 91 days in the current Certificate Year quarter, and the certificate is assigned Risk Profile D. The Certificate Fee is calculated in two steps:
1. The Covered Asset Pool ($100,000) value is multiplied by the Initial Certificate Fee Percentage for Risk Profile D (1.75%): ($100,000)×(0.0175)=$1,750.
2. Multiply the result from step 1 by the number of days in the current quarter (91) divided by the number of days in the Certificate Year (365): $1,750×(91/365)=$436.30.

Therefore, the Certificate Fee for the quarter would be $436.30. It should be appreciated that the Certificate Fee can be charged to the Certificate Owner periodically, on any number of different schedules, without departing from the spirit or scope of the invention.

The Certificate Fee can increase or decrease based on certain conditions associated with the Covered Asset Pool. In some embodiments, because the Certificate Fee is a percentage of the value of the Covered Asset Pool account, the amount of the Certificate Fee increases as the Covered Asset Pool increases (although the percentage(s) may remain the same).

In some embodiments, the Certificate Fee Percentage increases or decreases due to the assignment of a new risk profile to the certificate resulting from changes in the asset allocation of the Covered Asset Pool (e.g., market fluctuations, re-allocation of assets, contributions, or withdrawals). In some embodiments, the Certificate Fee Percentage changes automatically without advance notice to the Certificate Owner.

For example, the certificate of Certificate Owner A had previously been assigned Risk Profile D at time t1 102. As a result, the Certificate Fee Percentage for Risk Profile D that is applicable to Certificate Owner A's certificate is 1.75%, and the fee is charged to Certificate Owner A. During the next three months, Certificate Owner A decided to contribute additional cash to his investment account and invest the cash in Core Fixed assets—bringing the asset category allocation of his Covered Asset Pool to 32% Core Fixed; 46% Core Equity; and 21% International. As a result, Certificate Owner A's Covered Asset Pool now has an overall asset allocation of 32% Core Fixed assets and 68% non-Core Fixed Assets. At the end of the three-month period, the computing device 202 determines that Certificate Owner A's certificate no longer complies with Risk Profile D because the ratio of equity assets to total assets has fallen below 70%. The computing device 202 assigns Risk Profile C to the certificate because the asset allocation in the Covered Asset Pool now satisfies the requirements for Risk Profile C. The particular asset category allocation for Certificate Owner A's Covered Asset Pool still meets the minimum and maximum investment percentages for the individual asset categories. The computing device 202 also adjusts the Certificate Fee Percentage applicable to Certificate Owner A from 1.75% to 1.52% because the assigned risk profile changed from Risk Profile D to Risk Profile C, and the computing device 202 charges a fee based on the new percentage.

In another example, the certificate of Certificate Owner B had previously been assigned Risk Profile A at time t1 102. As a result, the Certificate Fee Percentage for Risk Profile A that is applicable to Certificate Owner B's certificate is 1.00%, and the fee is charged to Certificate Owner B. During the next three months, Certificate Owner B decided to reallocate the assets in her Covered Asset Pool to 48% Core Fixed; 50% Core Equity; and 2% Alternative. As a result, Certificate Owner B's Covered Asset Pool now has an overall asset allocation of 48% Core Fixed assets and 52% non-Core Fixed Assets. At the end of the three-month period, the computing device 202 determines that Certificate Owner B's certificate no longer complies with Risk Profile A because the ratio of equity assets to total assets has risen above 50%. The computing device 202 assigns Risk Profile B to the certificate because the asset allocation in the Covered Asset Pool now satisfies the overall asset allocation rule for Risk Profile B. The particular asset category allocation for Certificate Owner B's Covered Asset Pool still meets the minimum and maximum investment percentages for the individual asset categories. The computing device 202 also adjusts the Certificate Fee Percentage applicable to Certificate Owner B from 1.00% to 1.24% because the assigned risk profile changed from Risk Profile A to Risk Profile B, and the computing device 202 charges a fee based on the new percentage.

The computing device 202 prioritizes charging of the fee to a second account of the Certificate Owner that is not the investment account linked to the guarantee product. An advantage of this technique is that the guarantor can offer lower-cost products because the value of the investment account is not reduced by the fees. Therefore, the asset value of the investment account is generally more likely to avoid triggering the benefit payments (e.g., by remaining above a zero-dollar value longer) until a later date (if at all).

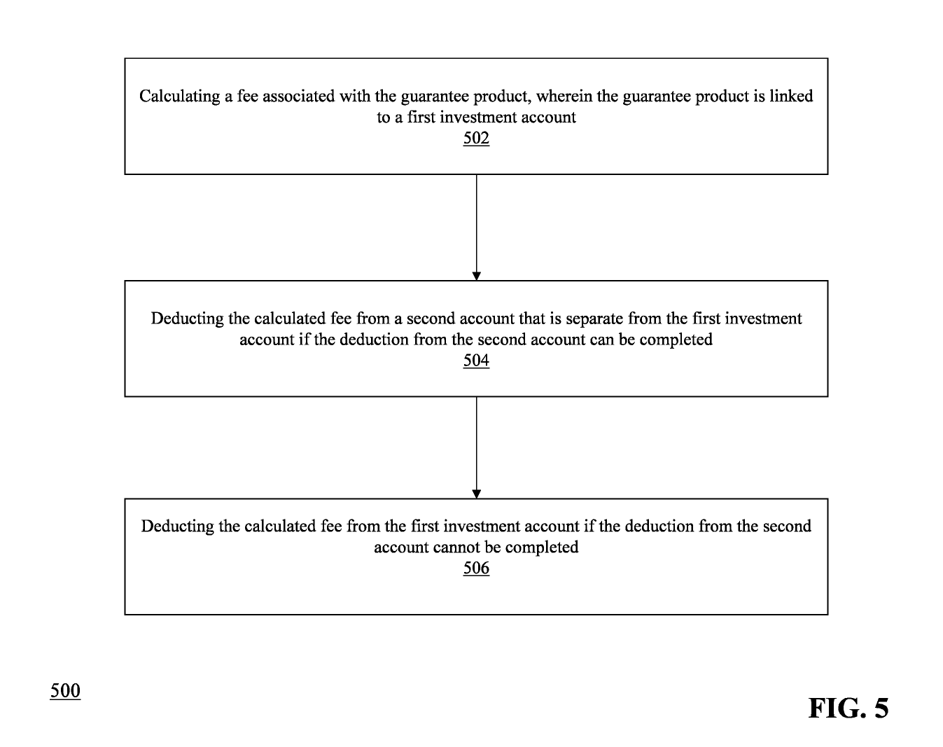

FIG. 5 is a flow diagram of a method 500 for charging of fees associated with a guarantee product (e.g., the annuity certificate), using the system of FIG. 2. The computing device 202 calculates (502) a fee (e.g., the Certificate Fee) associated with the guarantee product (e.g., certificate) linked to the first investment account (e.g., the Covered Asset Pool account). The computing device 202 deducts (504) the calculated fee from a second account that is not covered by the guarantee product if deduction of the fee from the second account can be completed. The computing device 202 deducts (506) the calculated fee from the Covered Asset Pool account if deduction of the calculated fee from the second account cannot be completed. In some embodiments, the second account is a cash account, a money market account, a bank account, a checking account, a savings account, a mutual fund account, an investment account, a brokerage account, or a trust account. The second account can be held by a financial institution that is different from the guarantor offering the guarantee product.

There may be a number of different reasons why the calculated fee cannot be deducted from the second account. For example, the second account may have insufficient funds to cover the calculated fee. In another example, the financial institution that holds or manages the second account may reject the deduction of the calculated fee. In another example, the transaction to deduct the calculated fee from the second account may fail, e.g., due to a transmission error. Because in some cases the guarantor may terminate the guarantee product if the associated fees are not timely paid, the computing device 202 deducts the calculated fee from the Covered Asset Pool account to ensure that the fees are paid and the product remains in effect.

In some embodiments, the computing device 202 adjusts the guarantee associated with the guarantee product whenever the calculated fee is deducted from the Covered Asset Pool account. For example, the computing device 202 can decrease the Coverage Base under the guarantee product when the calculated fee is deducted from the Covered Asset Pool account because the value of that account has been reduced.

In some embodiments, the computing device 202 deducts the calculated fee from one or more additional accounts that are not covered by the guarantee product if the calculated fee cannot be deducted from the second account. The Certificate Owner can establish a hierarchy of accounts from which the calculated fee can be deducted. For example, the second account can be a savings account located at the Certificate Owner's primary bank, a third account can be a 401(k) account held by the Certificate Owner's employer, and a fourth account can be a trust account accessible to the Certificate Owner. The computing device 202 attempts to deduct the fee from the savings account, but the savings account does not have enough funds available to cover the fee.

In some embodiments, the computing device 202 can withdraw some or all of the available funds from the savings account and then attempt to deduct the remaining fee amount from the 401(k) account, trust account, and then the Covered Asset Pool account until the fee is fully paid. In some embodiments, the computing device 202 can attempt to withdraw the fee amount from each of the accounts in a specific order (e.g., savings account→401(k) account→trust account) until the computing device 202 locates an account with sufficient funds to cover the fee. If no such account is available, the computing device 202 can deduct the fee from the Covered Asset Pool account.

In some embodiments, the computing device 202 transmits a notice to the Certificate Owner when deduction of the calculated fee from the second account cannot be completed. The notice can indicate that the fee was deducted from one or more other accounts and/or from the Covered Asset Pool account. In the event that some or all of the fee is deducted from the Covered Asset Pool account, the notice can provide a limited time period during which the Certificate Owner must pay the fee through alternative means (e.g., an account transfer, a cash/check/credit card payment, or other types of payment methods) so that the fee payment deducted from the Covered Asset Pool account can be reversed. If the Certificate Owner pays the fee in a timely fashion, the computing device 202 can reverse any adjustments made to the guarantee under the guarantee product that were made when the fee was deducted from the Covered Asset Pool account.

In some embodiments, the computing device 202 transmits a notice to the Certificate Owner that the calculated fee is due and provide the Certificate Owner with instructions to pay the fee via independent means (i.e., not an automatic transfer from another account). For example, the notice can instruct the Certificate Owner to submit a check to the guarantor to cover the fee.

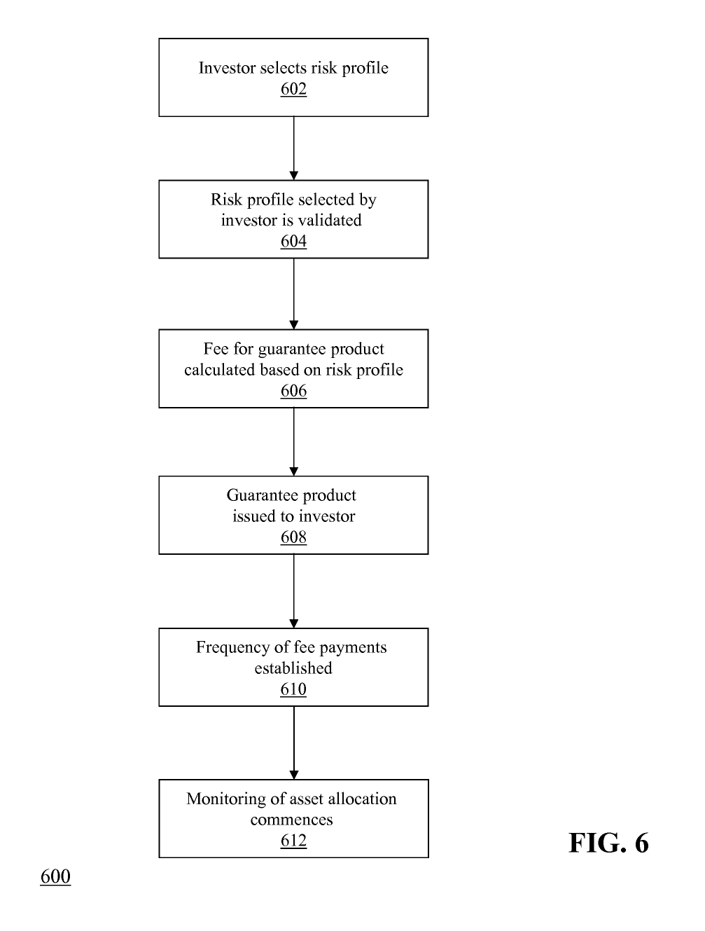

FIGS. 6-11 are workflow diagrams of a method for establishing and monitoring risk profiles associated with a guarantee product, adjusting risk profiles associated with the guarantee product, and calculating and charging fees associated with the guarantee product, using the system 200 of FIG. 2. In FIG. 6, the investor (e.g., Certificate Owner) who is purchasing the guarantee product selects (602) a risk profile from the plurality of available risk profiles, and the computing device 202 receives the risk profile selection. In some embodiments, the investor (or his investment advisor) reallocates the assets in the investment account associated with the guarantee product to match the selected risk profile.

The computing device 202 validates (604) the selected risk profile with the allocation of assets in the investment account. For example, the computing device 202 compares the risk level of the selected risk profile with the allocation of assets in the investment account to determine whether the allocation of assets is in compliance with the risk profile. The computing device 202 can also compare the allocation in the particular asset categories within the investment account against the defined minimum and maximum investment percentages for the asset categories in the selected risk profile to determine whether the allocation of assets is in compliance with the risk profile. The computing device 202 calculates (606) a fee associated with the guarantee product based a fee amount assigned to the selected risk profile.

The computing device 202 issues (608) the guarantee product to the investor. The computing device 202 establishes (610) a frequency of fee payments under the guarantee product. In some embodiments, the computing device 202 receives a desired frequency of fee payments from the investor and uses that to establish the frequency of fee payments. For example, the frequency of fee payments can be determined according to a periodic schedule (e.g., monthly, every three months, every six months, every year). In some embodiments, the computing device 202 charges an initial fee payment to the investor at the time the guarantee product is issued. The computing device 202 commences (612) monitoring of the allocation of assets in the investment account for compliance with the assigned risk profile. The computing device 202 can monitor the allocation of assets on a periodic basis (e.g., daily, weekly, monthly or every three months) and/or according to checkpoints defined in the guarantee product (e.g., each Certificate Year or on the Lock-In Date).

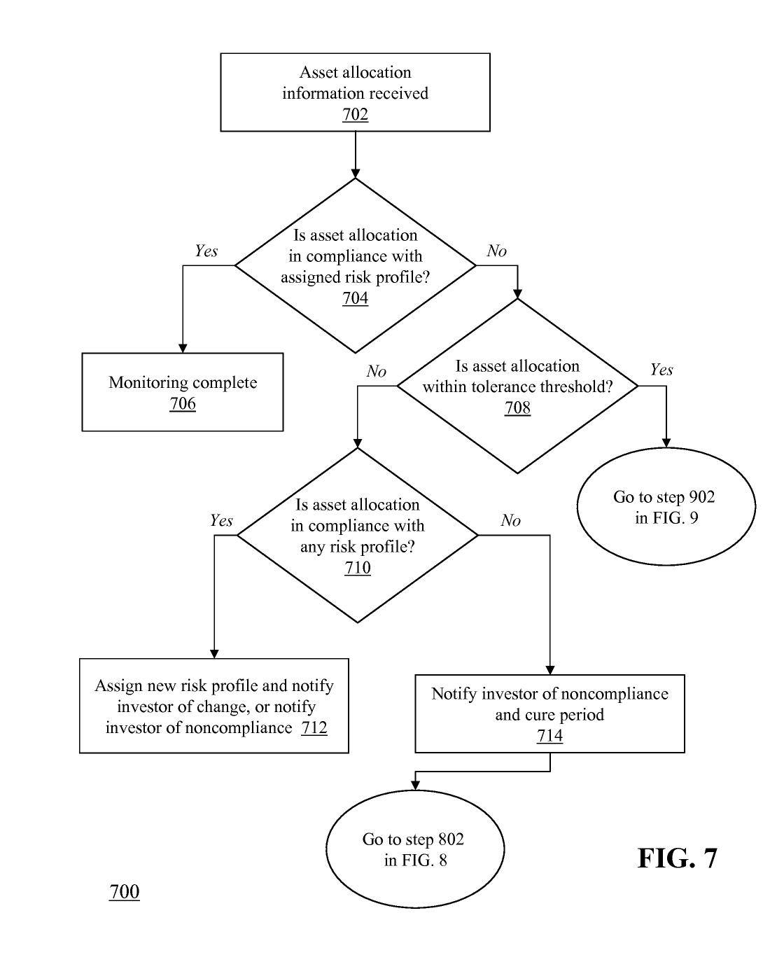

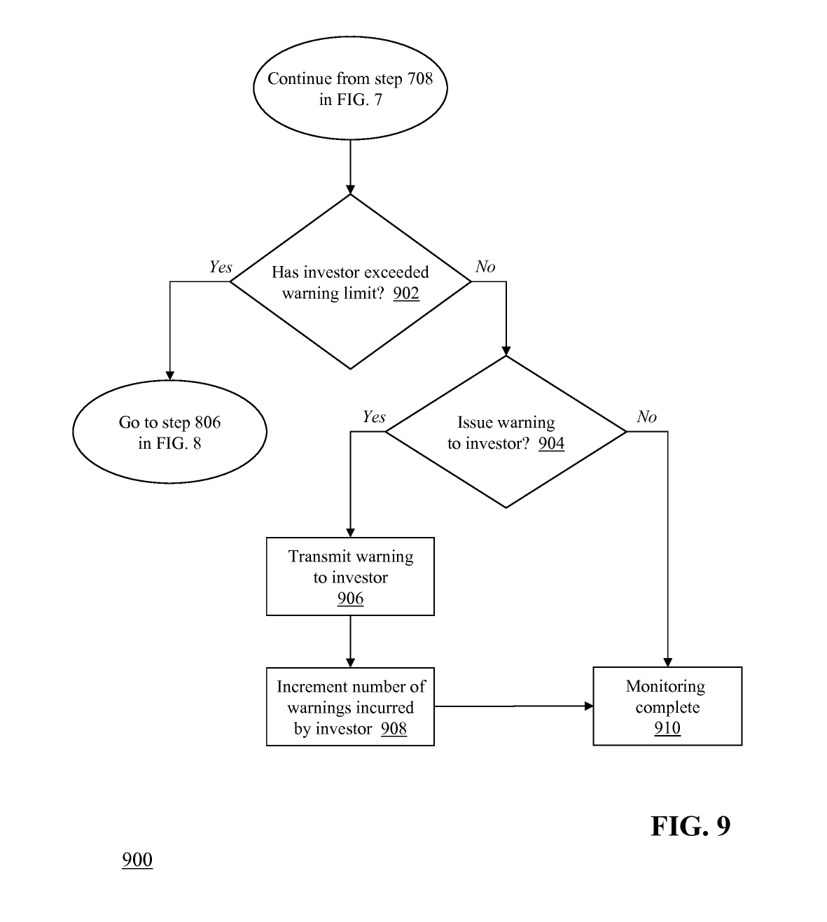

Turning to FIG. 7, the computing device 202 receives (702) asset allocation information for the investment account linked to the guarantee product. The computing device 202 determines (704) whether the asset allocation is in compliance with the currently-assigned risk profile. If the asset allocation is in compliance, the computing device 202 completes (706) the monitoring process until the next monitoring period is scheduled. If the asset allocation is not in compliance, the computing device 202 determines (708) whether the asset allocation in the investment account falls within a tolerance threshold of the risk level associated with the assigned risk profile. If the asset allocation is within the tolerance threshold, the computing device 202 moves to step 902 in FIG. 9.

If the asset allocation is not within the tolerance threshold, the computing device 202 determines (710) whether the asset allocation is in compliance with any of the plurality of risk profiles. If the asset allocation is in compliance with another risk profile, the computing device 202 assigns (712) the other risk profile to the guarantee product. In some embodiments, the computing device 202 notifies the investor that the assigned risk profile has been changed. In some embodiments, the computing device 202 does not assign the other risk profile but notifies the investor that his asset allocation is not in compliance with the assigned risk profile.

If the asset allocation is not in compliance with any of the plurality of risk profiles, the computing device 202 notifies (714) the investor of the noncompliance and informs the investor of a specified cure period in which the investor can rebalance the asset allocation to comply with the assigned risk profile (or another risk profile).

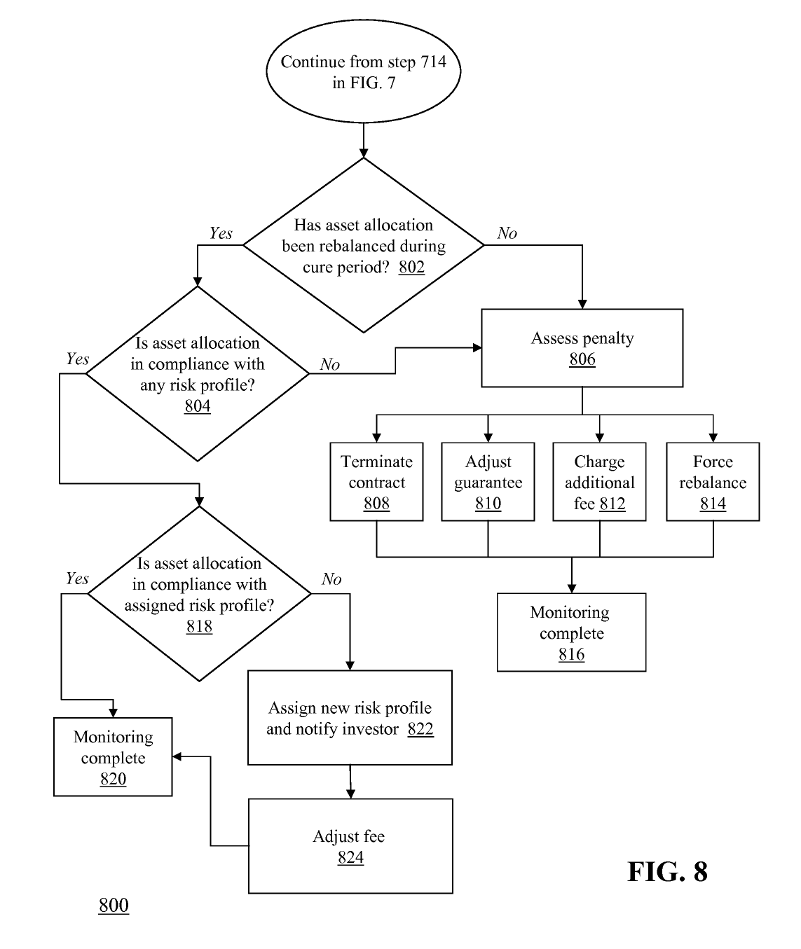

Turning to FIG. 8, after the computing device has notified the investor of noncompliance (step 714 of FIG. 7), the computing device 202 determines (802) whether the investor's asset allocation has been rebalanced during the cure period. If the asset allocation has not been rebalanced, the computing device 202 assesses (806) a penalty to the guarantee product. If the asset allocation has been rebalanced, the computing device 202 determines (804) whether the rebalanced asset allocation is in compliance with any of the plurality of risk profiles. If the asset allocation is not in compliance with any of the plurality of risk profiles, the computing device 202 assesses (806) a penalty to the guarantee product.

In assessing the penalty, the computing device 202 can:

Terminate (808) the guarantee product;

Adjust (810) the guarantee (e.g., reduce the Coverage Base and/or Coverage Amount);

Charge (812) a fee to the investor that may be in addition to the standard fees; and/or

Force (814) a rebalancing of the investor's asset allocation to comply with one of the risk profiles.

Upon completing the penalty assessment, the computing device 202 completes (816) the monitoring process until the next monitoring period is scheduled.

Going back to step 804, if the computing device 202 determines that the asset allocation is in compliance with at least one of the risk profiles, the computing device 202 determines (818) whether the asset allocation is in compliance with the currently-assigned risk profile. If the asset allocation is in compliance with the currently-assigned risk profile, the computing device completes (820) the monitoring process until the next monitoring period is scheduled. If the asset allocation is not in compliance with the currently-assigned risk profile, the computing device 202 assigns (822) a new, compliant risk profile to the guarantee account and notifies the investor that a new risk profile has been assigned. Because the new risk profile is associated with a different fee amount, the computing device 202 adjusts (824) the fee associated with the investor's guarantee product based on the fee amount of the new risk profile. In some embodiments, the computer device 202 charges the adjusted fee upon changing to the new risk profile. In some embodiments, the computing device 202 does not charge the adjusted fee until the next scheduled fee payment date for the guarantee product. The computing device 202 may pro-rate the fee based on the time at which the risk profile was changed (e.g., based on the number of days that the new risk profile is assigned during the current fee period). The computing device 202 completes (820) the monitoring process until the next monitoring period is scheduled.

Turning to FIG. 9, after the computing device 202 has determined that the asset allocation is within a tolerance threshold associated with the currently-assigned risk profile (step 708 of FIG. 7), the computing device 202 determines (902) whether a warning limit has been exceeded for the applicable investor. For example, the computing device 202 can evaluate the number of times that the investor has been warned about noncompliance with the assigned risk profile (e.g., during a specified time period). If the warning limit has been exceeded, the computing device 202 moves to step 806 in FIG. 8.

If the warning limit has not been exceeded, the computing device 202 determines (904) whether to issue a warning to the investor. If the computing device 202 issues a warning, the computing device 202 transmits (906) a warning notification to the investor and increments (908) the number of warnings incurred by that investor. The computing device 202 completes (910) the monitoring process until the next monitoring period is scheduled. If the computing device 202 does not issue a warning, the computing device 202 completes (910) the monitoring process until the next monitoring period is scheduled.

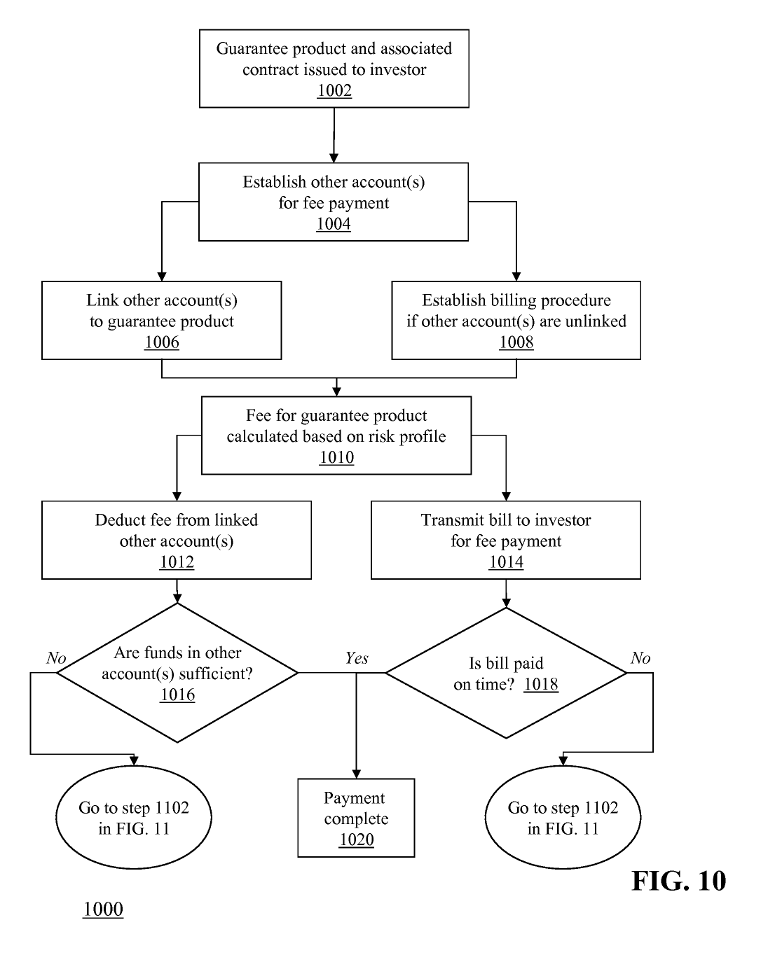

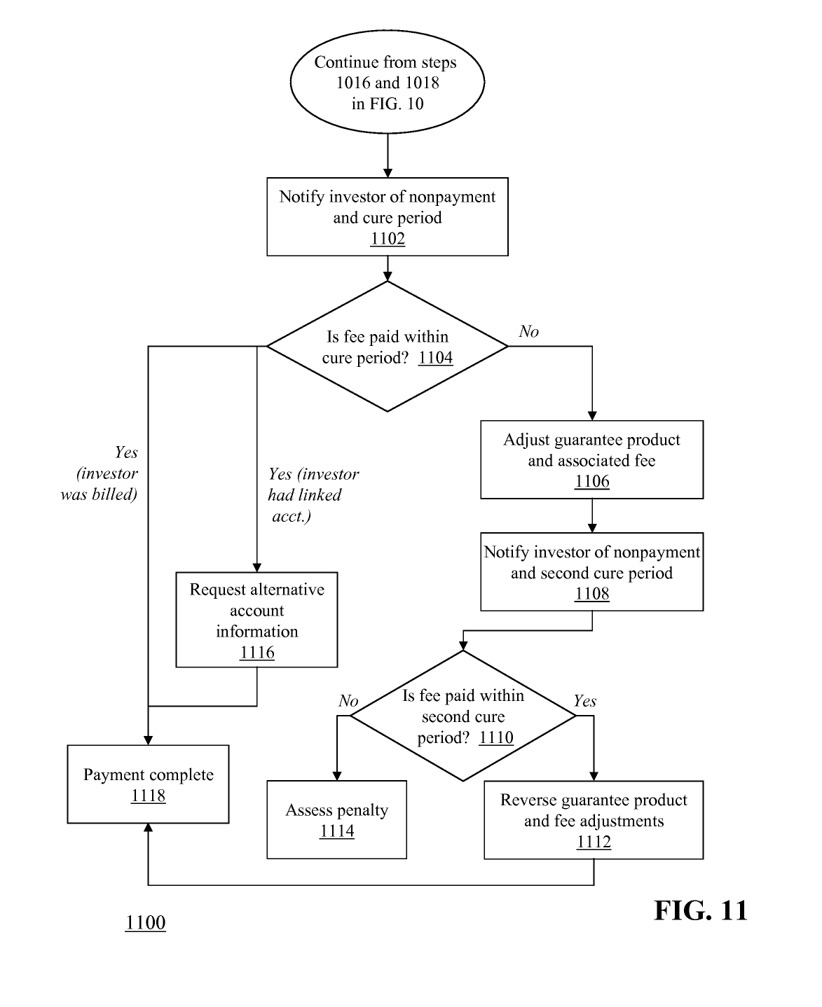

FIGS. 10 and 11 are workflow diagrams for calculating and charging fees associated with a guarantee product, using the system 200 of FIG. 2. Turning to FIG. 10, the computing device 202 issues (1002) the guarantee product to the investor. In some embodiments, the computing device 202 transmits to the investor a contract between the investor and the guarantor associated with the guarantee product. The computing device 202 establishes (1004) another account, or a plurality of other accounts, for fee payment. In some embodiments, the computing device 202 receives information for the other account(s) (e.g., routing number, financial institution name, account number) and links (1006) the other account(s) with the guarantee product. In some embodiments, the computing device 202 establishes (1008) a procedure to bill the investor if the investor does not provide information for another account to be linked. The computing device 202 calculates (1010) a fee for the guarantee product based on the fee amount defined for the risk profile selected by the investor and assigned to the guarantee product.

In embodiments where the computing device 202 has linked other account(s), the computing device 202 deducts (1012) the fee from the other account(s). The computing device 202 determines (1016) whether the other accounts(s) have sufficient funds to complete the deduction and payment of the fee. If the other account(s) do not have sufficient funds, the computing device 202 moves to step 1102 of FIG. 11. If the other account(s) do have sufficient funds, the computing device 202 deducts the fee and completes (1020) the fee payment.

In embodiments where the computing device 202 has established a billing procedure for the investor, the computing device 202 transmits (1014) a bill to the investor for remittance of the fee. The computing device 202 determines (1018) whether the bill has been paid in a timely fashion. If the bill has not been paid, the computing device 202 moves to step 1102 of FIG. 11. If the bill has been paid, the computing device 202 completes (1020) the fee payment.

Turning to FIG. 11, in embodiments where either the other account(s) do not have sufficient funds or the bill has not been paid, the computing device notifies (1102) the investor of non-payment and provides an applicable time period during which the investor can cure the defect and make payment. The computing device 202 determines (1104) whether the fee has been paid within the cure period. If the fee has been paid and the computing device 202 had previously transmitted a bill to the investor, the computing device 202 completes (1118) the fee payment. If the fee has been paid and the computing device 202 had previously linked other account(s) to the guarantee product, the computing device 202 requests (1116) information for an alternative account to be linked to the guarantee product. The computing device completes (1118) the fee payment.

Going back to step 1104, if the fee is not paid within the cure period, the computing device adjusts (1106) the guarantee product (e.g., reducing the Coverage Base and/or Coverage Amount) and/or adjusts the fee associated with the guarantee product. The computing device 202 notifies (1108) the investor of non-payment and provides a second applicable time period during which the investor can cure the defect and make payment. The computing device 202 determines (1110) whether the fee has been paid within the second cure period. If the fee has been paid, the computing device 202 reverses (1112) the adjustments previously made to the guarantee product and/or the associated fee (step 1106). In some embodiments, the reversal of adjustments is subject to a processing fee or additional penalty. The computing device completes (1118) the fee payment.

If the fee has not been paid within the second cure period, the computing device 202 can assess a penalty to the guarantee product, including but not limited to further adjustment to the guarantee product and/or associated fee, charging of additional fees, and termination of the guarantee product.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, both general and special purpose microprocessors, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computer in communication with a display device, e.g., a CRT (cathode ray tube), plasma, or LCD (liquid crystal display) monitor, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VoIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, a 3GPP Long Term Evolution (LTE) protocol, and/or other communication protocols.

Devices of the computing system can include, for example, a computer, a computer with a browser device, a telephone, an IP phone, a mobile device (e.g., cellular phone, personal digital assistant (PDA) device, laptop computer, tablet device, electronic mail device), and/or other communication devices. The browser device includes, for example, a computer (e.g., desktop computer, laptop computer) with a World Wide Web browser (e.g., Microsoft® Internet Explorer® available from Microsoft Corporation, Mozilla® Firefox available from Mozilla Corporation). Mobile computing device includes, for example, a Blackberry®, an iPhone®. IP phones include, for example, a Cisco® Unified IP Phone 7985G available from Cisco Systems, Inc, and/or a Cisco® Unified Wireless Phone 7920 available from Cisco Systems, Inc.

Comprise, include, and/or plural forms of each are open ended and include the listed parts and can include additional parts that are not listed. And/or is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the invention described herein.

1. A computerized method for assigning a risk profile to a guarantee product, the method comprising:
establishing, by a computing device, a plurality of risk profiles each based on a risk level;
assigning, by the computing device, a first risk profile to the guarantee product based on an initial allocation of assets in an investment account linked to the guarantee product;
periodically determining, by the computing device, whether the guarantee product is in compliance with the first risk profile due to changes in the initial allocation of assets, including determining whether the allocation of assets in the investment account satisfies the risk level of the first risk profile; and
assigning, by the computing device, a second risk profile to the guarantee product based on a current allocation of assets in the investment account whenever the guarantee product is no longer in compliance with the first risk profile based on the current allocation of assets.

2. The method of claim 1, wherein the risk level is based on a ratio of equity assets to total assets.

3. The method of claim 1, wherein each risk profile includes one or more asset categories defined by a minimum investment percentage and a maximum investment percentage.

4. The method of claim 3, wherein the step of determining whether the allocation of assets in the investment account satisfies the risk level of the first risk profile includes determining whether the allocation of assets in the investment account satisfies the minimum investment percentage and the maximum investment percentage for each of the asset categories in the first risk profile.

5. The method of claim 3, wherein the one or more asset categories include one or more of: a core fixed category, a core equity category, an international category, a small/mid cap category, and an alternative category.

6. The method of claim 1, the determining step further comprising:
comparing, by the computing device, the allocation of assets in the investment account with the risk level of the first risk profile to produce a comparison value; and
determining, by the first computing device, whether the comparison value satisfies a tolerance threshold.

7. The method of claim 6, further comprising:
transmitting, by the computing device, a notice to an owner of the guarantee product whenever the comparison value exceeds the tolerance threshold.

8. The method of claim 6, further comprising:
reallocating, by the computing device, the assets in the investment account to bring the guarantee product into compliance with the first risk profile whenever the comparison value exceeds the tolerance threshold.

9. The method of claim 1, further comprising:
transmitting, by the computing device, a notice to an owner of the guarantee product when the second risk profile is assigned.

10. The method of claim 1, further comprising:
transmitting, by the computing device, a notice to an owner of the guarantee product whenever the guarantee product is no longer in compliance with the first risk profile due to changes in the initial allocation of assets and before the second risk profile is assigned.

11. The method of claim 1, further comprising:
reallocating, by the computing device, the assets in the investment account to achieve compliance with the first risk profile whenever the guarantee product is no longer in compliance with the first risk profile due to changes in the initial allocation of assets.

12. The method of claim 1, further comprising:
transmitting, by the computing device, a notice to an owner of the guarantee product whenever the guarantee product is no longer in compliance with the first risk profile due to changes in the initial allocation of assets, and the current allocation of assets in the investment account does not satisfy the risk level of any of the risk profiles.

13. The method of claim 12, further comprising:
assessing, by the computing device, a penalty against the guarantee product whenever the guarantee product is not in compliance with any of the risk profiles on a predetermined date after the notice is transmitted.

14. The method of claim 13, wherein the penalty includes termination of the guarantee product, reallocation of the assets in the investment account to bring the guarantee product into compliance with at least one risk profile, reduction of the guarantee associated with the guarantee product, or a fee charged to the guarantee product.

15. The method of claim 1, further comprising:
assigning, by the computing device, a third risk profile to the guarantee product based on a current allocation of assets in the investment account if the guarantee product is no longer in compliance with the first risk profile or the second risk profile based on the current allocation of assets.

16. The method of claim 1, the plurality of risk profiles each associated with a fee amount, the method further comprising:
calculating, by the computing device, a fee to be charged to the guarantee product based on the fee amount associated with the first risk profile;
charging, by the computing device, the calculated fee to the guarantee product; and
adjusting, by the computing device, the calculated fee to be charged to the guarantee product whenever the assigned risk profile changes, the adjusted fee based on the fee amount associated with the newly-assigned risk profile.

17. The method of claim 1, wherein the guarantee product includes at least one of: an immediate or deferred fixed or variable annuity, a contingent deferred annuity, or a standalone living benefit.

18. The method of claim 1, wherein the guarantee associated with the guarantee product includes at least one of: a guaranteed minimum death benefit, an income benefit, a withdrawal benefit, a lifetime withdrawal benefit, or an account value guarantee.

19. The method of claim 1, wherein a cash account is established within the investment account, the guarantee applies only to the non-cash account portion of the investment account, and a fee associated with the guarantee product is deducted from the cash account.

20. The method of claim 1, wherein a second investment account is established within the investment account and the guarantee does not apply to the second investment account.

21. A system for assigning a risk profile to a guarantee product, the system comprising:
a computing device configured to:
establish a plurality of risk profiles each based on a risk level;
assign a first risk profile to the guarantee product based on an initial allocation of assets in an investment account linked to the guarantee product;
periodically determine whether the guarantee product is in compliance with the first risk profile due to changes in the initial allocation of assets, including determining whether the allocation of assets in the investment account satisfies the risk level of the first risk profile; and
assign a second risk profile to the guarantee product based on a current allocation of assets in the investment account whenever the guarantee product is no longer in compliance with the first risk profile based on the current allocation of assets.

22. A computer program product, tangibly embodied in a non-transitory computer readable storage medium, for assigning a risk profile to a guarantee product, the computer program product including instructions operable to cause a computing device to:
establish a plurality of risk profiles each based on a risk level;
assign a first risk profile to the guarantee product based on an initial allocation of assets in an investment account linked to the guarantee product;
periodically determine whether the guarantee product is in compliance with the first risk profile due to changes in the initial allocation of assets, including determining whether the allocation of assets in the investment account satisfies the risk level of the first risk profile; and
assign a second risk profile to the guarantee product based on a current allocation of assets in the investment account whenever the guarantee product is no longer in compliance with the first risk profile based on the current allocation of assets.

23. A computerized method for charging of fees associated with a guarantee product, the method comprising:
calculating, by a computing device, a fee associated with the guarantee product, wherein the guarantee product is linked to a first investment account;
deducting, by the computing device, the calculated fee from a second account that is separate from the first investment account if deduction of the fee from the second account can be completed; and
deducting, by the computing device, the calculated fee from the first investment account if deduction from the second account cannot be completed, wherein a guarantee associated with the guarantee product is adjusted based on deduction from the first investment account.

24. The method of claim 23, further comprising:
deducting, by the computing device, the calculated fee from one or more other accounts that are separate from the first investment account if the deduction from the second account cannot be completed and before deducting the calculated fee from the first investment account; and
deducting, by the computing device, the calculated fee from the first investment account if the deduction from the one or more other accounts cannot be completed, wherein the guarantee associated with the guarantee product is adjusted based on deduction of the calculated fee from the first investment account.

25. The method of claim 23, further comprising:
transmitting, by the computing device, a notice to an owner of the second account if the deduction from the second account cannot be completed and before deducting the calculated fee from the first investment account.

26. The method of claim 23, further comprising:
transmitting, by the computing device, a notice to an owner of the second account if the deduction from the second account cannot be completed and after deducting the calculated fee from the first investment account, wherein the guarantee associated with the guarantee product is adjusted based on deduction of the calculated fee from the first investment account.

27. The method of claim 26, further comprising:
receiving, by the computing device, payment of the calculated fee from the owner of the second account; and
reversing, by the computing device, the adjustment made to the guarantee associated with the guarantee product.

28. The method of claim 23, wherein the second account is a cash account, a money market account, a bank account, a checking account, a savings account, a mutual fund account, an investment account, a brokerage account, or a trust account.

29. The method of claim 23, wherein the one or more other accounts include a cash account, a money market account, a bank account, a checking account, a savings account, a mutual fund account, an investment account, a brokerage account, or a trust account.

30. The method of claim 23, wherein the deduction from the second account cannot be completed due to at least one of: insufficient funds available in the second account, a rejection of the deduction from a financial institution managing the second account, and a transaction error resulting from initiation of the deduction.

31. The method of claim 23, further comprising:
transmitting, by the computing device, an invoice for the calculated fee to an owner of the second account if the deduction from the second account cannot be completed and before deducting the calculated fee from the first investment account; and
receiving, by the computing device, payment for the calculated fee from the owner of the second account.

32. The method of claim 31, wherein payment for the calculated fee is received via a manual funds transfer.

33. The method of claim 32, wherein the manual funds transfer includes at least one of: payment by check, wire transfer, Automated Clearing House (ACH) transfer, payment by credit card, payment by debit card, or payment by money order.

34. A computerized method for charging of fees associated with a guarantee product, the method comprising:
calculating, by a computing device, a fee associated with the guarantee product, wherein the guarantee product is linked to a first investment account;
deducting, by the computing device, the calculated fee from a second account if the deduction from the second account can be completed;
deducting, by the computing device, the calculated fee from one or more other accounts if the deduction from the second account cannot be completed;
deducting, by the computing device, the calculated fee from the first investment account if the deduction from the one or more other accounts cannot be completed, wherein the guarantee associated with the guarantee product is adjusted based on deduction from the first investment account.

35. The method of claim 34, further comprising:
transmitting, by the computing device, a notice to an owner of the second account if the deduction from the second account cannot be completed and before deducting the calculated fee from the first investment account.
